(19) United States
(12) Patent Application Publication
(10) Pub. No.: US 2018/0109758 A1
(43) Pub. Date: Apr. 19, 2018

(54) TRANSMISSION SYSTEM, TRANSMISSION TERMINAL, METHOD AND PROGRAM

(71) Applicants: Takeshi HOMMA, Kanagawa (JP); Hideki SHIRO, Kanagawa (JP)

(72) Inventors: Takeshi HOMMA, Kanagawa (JP); Hideki SHIRO, Kanagawa (JP)

(21) Appl. No.: 15/557,348

(22) PCT Filed: Mar. 4, 2016
(86) PCT No.: PCT/JP2016/001206

§ 371 Date: Sep. 11, 2017

(30) Foreign Application Priority Data
Mar. 17, 2015 (JP) 2015-054028

(51) Int. Cl. H04N 7/15; H04M 3/56; H04N 7/14; H04L 29/06

(52) U.S. Cl. CPC H04N 7/15; H04M 3/567; H04L 63/102; H04L 63/083; H04N 7/147

(57) ABSTRACT

A transmission system includes a first transmission terminal and a second transmission terminal. The second transmission terminal includes a pairing unit to perform pairing between the first and the second transmission terminals, and a transmitting unit to transmit, upon receipt of a communications start request from a third transmission terminal, information specifying communications with the third transmission terminal and individual account information of the second transmission terminal to the first transmission terminal on which the pairing is performed. The first transmission terminal includes a pairing unit to perform pairing between the first and the second transmission terminals, a receiving unit to receive information specifying communications with the third transmission terminal and individual account information of the second transmission terminal from the second transmission terminal on which the pairing is performed, and a communications start unit to start communications with the third transmission terminal based on the received information.

### TECHNICAL FIELD

The disclosures discussed herein relate to a transmission system, a transmission terminal, a method and a program.

### BACKGROUND ART

Progress of network environments has widely spread the use of remote communications technologies such as a TV conference.

Such remote communications technologies generally employ special-purpose apparatuses designed for a TV conference or the like as transmission terminals to perform remote communications. Such a special-purpose apparatus may be shared via a common account by users at different locations.

The common account, however, does not generally allow the users to specify individuals to have communications, and an increased number of recent special-purpose apparatuses are configured to allow the users to use their individual accounts (e.g., Patent Document 1).

The widespread use of mobile terminals (general-purpose apparatuses) such as smartphones has increasingly replaced the special-purpose apparatuses with the general-purpose apparatuses to use remote communications services such as a TV conference or the like.

### CITATION LIST

### Patent Literature

[PTL 1] Japanese Unexamined Patent Application Publication No. 2014-075074

### SUMMARY OF INVENTION

### Technical Problem

The recent general-purpose apparatuses are, as described above, capable of performing a TV conference or the like by receiving incoming calls and transmitting outgoing calls in a manner similar to the special-purpose apparatuses. However, the use of the special-purpose apparatuses may still be advantageous in terms of performance of cameras, displays, speakers and the like, and a substantial number of users may desire to use the special-purpose apparatuses to conduct the TV conference or the like when the special-purpose apparatuses are disposed nearby.

In this case, the users use individual accounts in the special-purpose apparatuses. Destination lists are generally managed by a server in association with respective accounts of the users, and are provided to the terminals of the users when the users log into the server. This may allow the commonly used special-purpose apparatus to display the destination lists of the individuals, which may increase risk of exposing the destination lists of the individuals to a third party. Further, the use of individual accounts in the commonly used special-purpose apparatus may also raise risk of allowing a third party to perform unauthorized operations while the users leave their seats for a second. Note that there are two methods in starting remote communications such as the TV conference, namely, (1) the user starts remote communications by selecting a destination of a counterpart and transmitting an outgoing call, and (2) the user starts remote communications by receiving an incoming call from the counterpart. The latter case has higher risk of exposing personal information such as the destination list of the user to a third party because the user is uncertain about when to receive the incoming call and is thus likely to leave his/her seat while waiting for receiving the incoming call. This may discourage the users to use their individual accounts in the special-purpose apparatuses.

### Solution to Problem

Accordingly, it is a general object in one embodiment of the present invention to provide a technology capable of collaborating a special-purpose apparatus with a general-purpose apparatus to allow a user to use an individual account to operate the special-purpose apparatus with higher security that substantially obviates one or more problems caused by the limitations and disadvantages of the related art.

According to an aspect of embodiments, there is provided a transmission system that includes a first transmission terminal; and a second transmission terminal. The second transmission terminal includes a pairing unit configured to perform pairing between the first transmission terminal and the second transmission terminal; and a transmitting unit configured to transmit, upon receipt of a communications start request from a third transmission terminal, information specifying communications with the third transmission terminal and individual account information of the second transmission terminal to the first transmission terminal on which the pairing is performed. The first transmission terminal includes a pairing unit configured to perform pairing between the first transmission terminal and the second transmission terminal; a receiving unit configured to receive information specifying communications with the third transmission terminal and individual account information of the second transmission terminal from the second transmission terminal on which the pairing is performed; and a communications start unit configured to start communications with the third transmission terminal based on the received information.

### Advantageous Effects of Invention

The embodiments may provide a technology to collaborate a special-purpose apparatus with a general-purpose apparatus, which enables a user to use his/her individual account to operate the special-purpose apparatus with excellent security.

### BRIEF DESCRIPTION OF DRAWINGS

FIG. 1 is a schematic diagram illustrating an example of a transmission system according to an embodiment;

FIG. 2 is a hardware configuration diagram illustrating an example of a TV conference-specific terminal according to an embodiment;

FIG. 3 is a hardware configuration diagram illustrating an example of a mobile terminal according to an embodiment;

FIG. 4 is a hardware configuration diagram of a transmission management system, a relay apparatus, a program providing system, and a maintenance system according to an embodiment;

FIG. 5 is a functional block diagram illustrating a transmission terminal, the relay apparatus, and the transmission management system constituting the transmission system according to the embodiment;

FIG. 6 is a diagram illustrating an example of an authentication management table;

FIG. 7 is a diagram illustrating an example of a terminal management table;

FIG. 8 is a diagram illustrating an example of a destination list management table;

FIG. 9 is a sequence diagram illustrating a process example upon activation of a terminal;

FIG. 10 is a sequence diagram illustrating a process example of pairing (1);

FIG. 11 is a diagram illustrating an example of a screen displaying a destination list and a two-dimensional code;

FIG. 12 is a diagram illustrating an example of data embedded in the two dimensional code;

FIG. 13 is a diagram illustrating an operation example of starting a pairing process;

FIG. 14 is a diagram illustrating an example of pairing acceptability response data;

FIG. 15 is a sequence diagram illustrating a process example of pairing (2);

FIG. 16 is a sequence diagram illustrating a process example of pairing (3);

FIG. 17 is a sequence diagram illustrating a process example of pairing (4);

FIG. 18 is a sequence diagram illustrating a process example upon receipt of an incoming call (1);

FIG. 19 is a diagram illustrating an operation example of responding to an individual client terminal upon receipt of an incoming call;

FIG. 20 is a diagram illustrating an example of conference attendance data;

FIG. 21 is a sequence diagram illustrating a process example upon receipt of an incoming call (2); and

FIG. 22 is a sequence diagram illustrating a process example upon receipt of an incoming call (3).

### DESCRIPTION OF EMBODIMENTS

The following describes preferred embodiments with reference to the accompanying drawings.

Overall Configuration of Embodiment

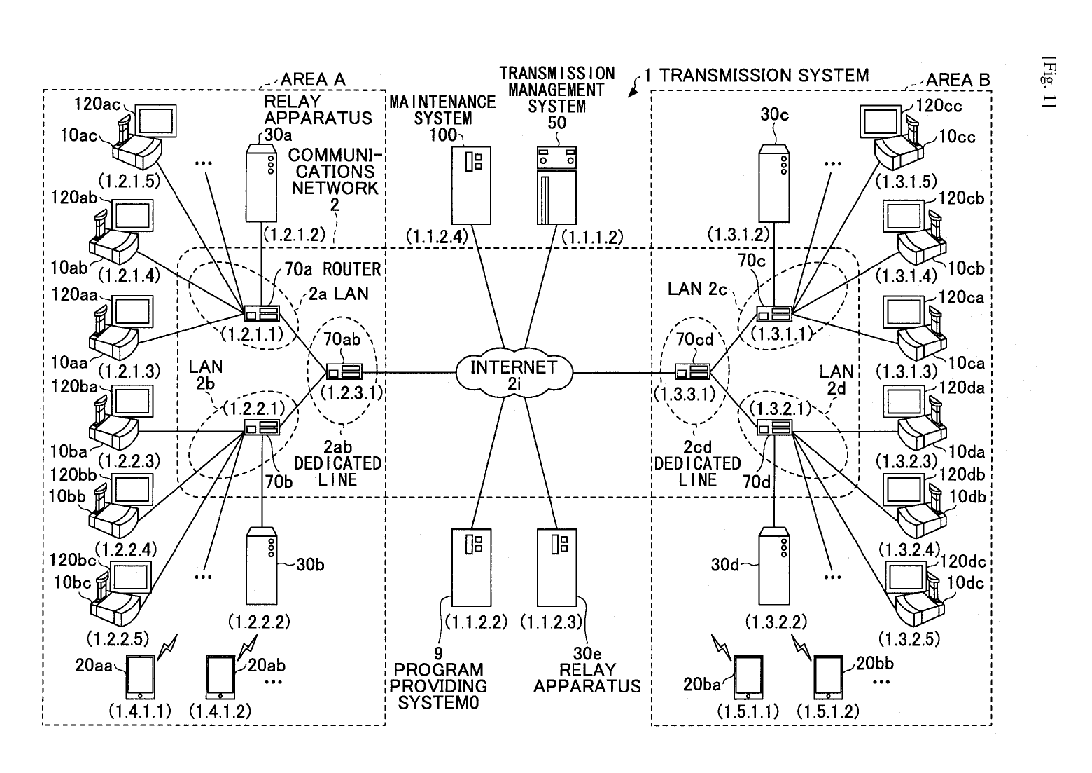

FIG. 1 is a schematic diagram illustrating a transmission system 1 according to an embodiment. The transmission system 1 according to the embodiment is initially outlined with reference to FIG. 1.

Note that examples of the transmission system 1 include a data providing system configured to transmit content data in one direction from one transmission terminal to another transmission terminal via a transmission management system, and a communications system configured to communicate information, emotions, and the like between two or more transmission terminals via a transmission management system. The communications system is configured to mutually communicate information, emotions, and the like between two or more communication terminals (corresponding to the “transmission terminals”) via a communication management system (corresponding to the “transmission management system”). Examples of such a communications system include a TV conference system, a video telephony system, an audio teleconference system, a voice telephony system, a PC (personal computer) screen sharing system, and the like.

The following illustrates the transmission system 1, the transmission management system 50, and the transmission terminal 10, on the basis of assumption of a TV conference system as an example of a communications system, a TV conference management system as an example of a communications management system, and a TV conference terminal as an example of a communications terminal. The transmission system according to the embodiments may be applied to the TV conference system as well as being applied to the communications system and the like.

The transmission system 1 illustrated in FIG. 1 is configured to include two or more first transmission terminals (10aa, 10ab, . . . ) serving as TV conference-specific terminals of special-purpose apparatuses, respective displays (120aa, 120ab, . . . ) of the transmission terminals (10aa, 10ab, . . . ), two or more second transmission terminals (20aa, 20ab, . . . ) serving as mobile terminals of general-purpose apparatuses, two or more relay apparatuses (30a, 30b, 30c, 30d, and 30e), a transmission management system 50, a program providing system 90, and a maintenance system 100. In the following embodiments, the “transmission terminals” may also be referred simply to as the “terminals”, and the “transmission management system” may be referred simply to as the “management system”.

In the illustration of the transmission system 1 according to the embodiments, a “transmission terminal 10” may represent any one of the transmission terminals (10aa, 10ab, . . . ), a “transmission terminal 20” may represent any one of the transmission terminals (20aa, 20ab, . . . ), a “display 120” may represent any one of the displays (120aa, 120ab, . . . ), and a “relay apparatus 30” may represent any one of the relay apparatuses (30a, 30b, 30c, 30d, and 30e).

The transmission terminals 10 and 20 are configured to transmit to and receive from other apparatuses various types of information. For example, the transmission terminals 10 and 20 establish a session with other terminals 10 and 20, and communicate content data such as sound-voice data and image data with other terminals 10 and 20 via the established session. The TV conference is implemented between two or more terminals 10 and 20 in the transmission system 1.

Note that the “content data” hereinafter represent “image data and sound-voice data”.

Note that the data transmitted between the terminals 10 and 20 are not limited to those illustrated in the embodiments. For example, the content data may be text data, or the content data may include sound-voice data, and image data in addition to the text data. Further, the image data may be dynamic image data or static image data. The image data may include both the dynamic image data and the static image data.

Further, to start a TV conference in the transmission system 1 of the embodiments, a user desiring to start the TV conference operates predetermined terminal 10 or 20, and the operated terminal 10 or 20 transmits start request information to the management system 50.

Note that the start request information indicates information that requests starting a session in the TV conference. The start request information includes information to specify a terminal 10 or 20 serving as a session partner. The terminal 10 or 20 that transmits the start request information is hereinafter referred to as a “start request terminal 10 or 20”. The counterpart terminal 10 or 20 specified as a session partner is hereinafter referred to as a “destination terminal 10 or 20”.

Note that the destination terminal (the session partner) 10 or 20 may be one terminal 10 or 20, or two or more terminals 10 or 20. Specifically, the transmission system 1 may implement a TV conference utilizing a session established not only between the two terminals 10 or 20 but also utilizing sessions between the three or more terminals 10 or 20.

The management system 50 is configured to manage the terminals 10 and 20, and the relay apparatuses 30 in an integrated fashion. The management system 50 establishes sessions between the terminals 10 and 20 to implement a TV conference via calls (voice communications) between the terminals 10 and 20.

When the management system 50 receives session start request information from the predetermined terminal 10 or 20, the management system 50 establishes a session between the terminal 10 or 20 (start request terminal) that transmits the start request information and the destination terminal 10 or 20 so as to start the TV conference.

Further, routers (70a, 70b, 70c, 70d, 70ab, and 70cd) illustrated in FIG. 1 are configured to select the optimal routes for content data. In the transmission system 1 according to the embodiments, a “router 70” represents any one of the routers (70a, 70b, 70c, 70d, 70ab, and 70cd). The relay apparatus 30 is configured to relay the content data between the terminals 10 and 20.

The program providing system 90 includes a not-illustrated hard disk (HD) storing terminal-specific programs for causing the terminal 10 or 20 to implement various types of functions, and may be able to transmit the terminal-specific programs to the terminal 10 or 20. The HD of the program providing system 90 further stores relay apparatus-specific programs for causing the relay apparatus 30 to implement various types of functions, and the program providing system 90 may be able to transmit the relay apparatus-specific programs to the relay apparatus 30. The HD of the program providing system 90 further stores transmission management-specific programs for causing the management system 50 to implement various types of functions, and the program providing system 90 may be able to transmit the transmission management-specific programs to the management system 50.

The maintenance system 100 is a computer configured to maintain, manage, or support at least one of the terminal 10 (20), the relay apparatus 30, the management system 50, and the program providing system 90. For example, when the maintenance system 100 is located domestically, and the terminals 10 and 20, the relay apparatus 30, the management system 50, and the program providing system 90 are located abroad, the maintenance system 100 remotely performs maintenance, management, support, and the like on at least one of the terminals 10 and 20, the relay apparatus 30, the management system 50, and the program providing system 90 via the communications network 2. Further, the maintenance system 100 may perform maintenance such as the management of the model number, the manufacturer's serial number, the customer, the maintenance and inspection, the management of the failure history, and the like on at least one of the terminals 10 and 20, the relay apparatus 30, the management system 50, and the program providing system 90 without being intervened by the communication network 2.

Moreover, the terminals (10aa, 10ab, 10ac, 10a . . . ), the relay apparatus 30a, and the router 70a are connected to one another via a LAN 2a such that the terminals (10aa, 10ab, 10ac, 10a . . . ), the relay apparatus 30a, and the router 70a may be communicate with one another. The terminals (10ba, 10bb, 10bc, 10b . . . ), the terminals (20aa, 20ab, . . . ), the relay apparatus 30b, and the router 70b are connected to one another via a LAN 2b such that the terminals (10ba, 10bb, 10bc, 10b . . . ), the terminals (20aa, 20ab, . . . ), the relay apparatus 30b, and the router 70b may be communicate with one another. Moreover, the LAN 2a and the LAN 2b are connected via a dedicated line 2ab including a router 70ab such that the LAN 2a and the LAN 2b may be communicate with each other. The LAN 2a and the LAN 2b are constructed within a predetermined area A. For example, the predetermined area A may be Japan, the LAN 2a may be constructed within a Tokyo Office, and the LAN 2b may be constructed within an Osaka Office.

The terminals (10ca, 10cb, 10cc, 10c . . . ), the relay apparatus 30c, and the router 70c are connected to one another via a LAN 2c such that the terminals (10ca, 10cb, 10cc, 10c . . . ), the relay apparatus 30c, and the router 70c may be communicate with one another. The terminals (10da, 10dd, 10dc, 10d . . . ), the relay apparatus 30d, and the router 70d are connected to one another via a LAN 2d such that the terminals (10da, 10dd, 10dc, 10d . . . ), the relay apparatus 30d, and the router 70d may be communicate with one another. The LAN 2c and the LAN 2d are connected via a dedicated line 2cd including a router 70cd such that the LAN 2c and the LAN 2d may be communicate with each other. The LAN 2c and the LAN 2d are constructed within a predetermined area B. For example, the predetermined area B may be the United States, the LAN 2c may be constructed within a NY Office, and the LAN 2d may be constructed within a Washington, D.C. Office. The area A and the area B are connected via the Internet 2i from the routers 70ab and 70cd such that the area A and the area B may be communicate with each other.

In addition, the management system 50 and the program providing system 90 are connected to the terminals 10 and 20 and the relay apparatus 30 via the Internet 2 such that the management system 50 and the program providing system 900 may be communicate with the terminals 10 and 20 and the relay apparatus 30. The management system 50 and the program providing system 90 may be installed within the area A or the area B, or may be installed within an area other than these areas.

The relay apparatus 30e is connected to the terminals 10 and 20 via the Internet 2i such that the relay apparatus 30e and the terminals 10 and 20 may be communicate with each other. The relay apparatus 30e is in constant operation. Hence, in order for the relay apparatus 30e to minimally receive adverse traffic effect of the local area A or B, the relay apparatus 30e is installed within the area other than the areas A and B. Thus, the relay apparatus 30e is used for relaying content data when the terminals 10 and 20 communicate with a terminal installed in another local area. Further, the relay apparatus 30e may also be used as an emergency relay apparatus when communications are performed between the terminals within the same local area and the relay apparatus installed within this area is failing or inactive.

Note that in the transmission system 1, LAN 2a, LAN 2b, the dedicated line 2ab, the Internet 2i, the dedicated line 2cd, the LAN 2c, and the LAN 2d form the communications network 2 of the embodiment. The communications network 2 may include parts that perform wired and wireless communications.

In FIG. 1, a combination of four numbers provided beneath each of the terminals 10 and 20, the relay apparatus 30, the management system 50, the router 70, the program providing system 90, and the maintenance system 100 simply represents an IP address of a general IPv4. For example, the IP address of the terminal 10aa is “1.2.1.3”. The IP address may be IPv6 instead of IPv4; however, the IPv4 is employed in this specification for simplifying the illustration.

Hardware Configuration of Embodiment

The following describes hardware configurations of the embodiment.

TV Conference-Specific Terminal

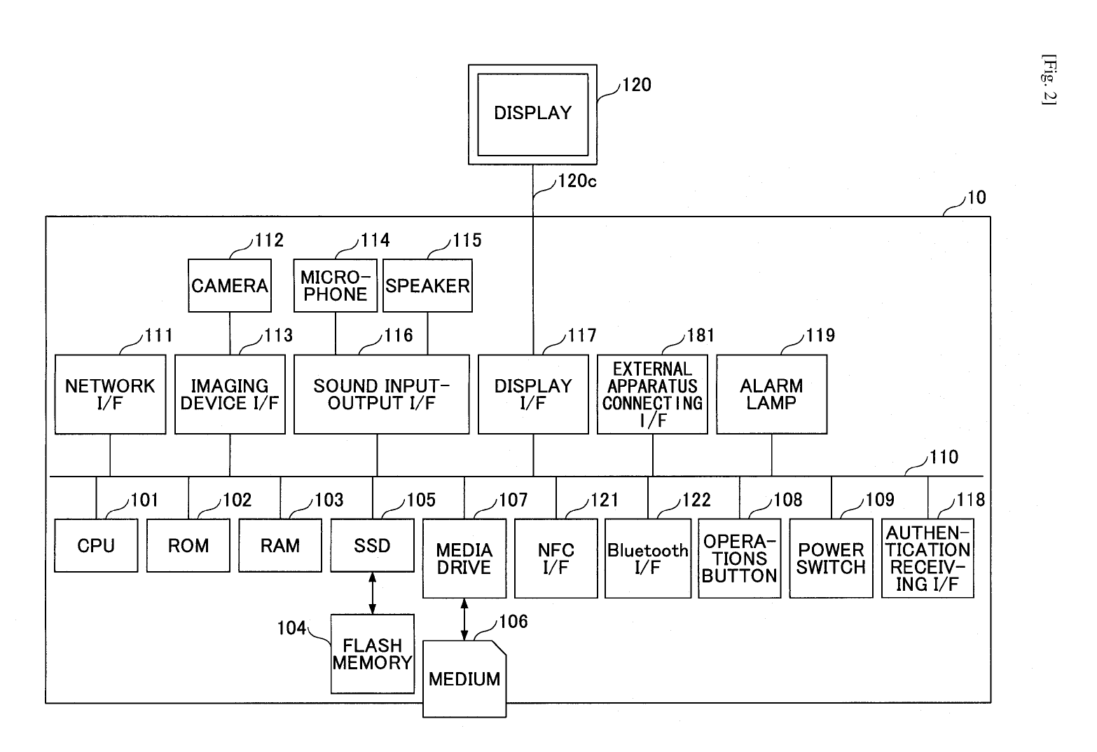

FIG. 2 is a hardware configuration diagram illustrating a TV conference-specific terminal 10. As illustrated in FIG. 2, the terminal 10 according to the embodiment includes a central processing unit (CPU) 101 configured to control overall operations of the terminal 10, a read only memory (ROM) 102 configured to store terminal-specific programs, a random access memory (RAM) 103 configured to serve as a work area of the CPU 101, a flash memory 104 configured to store various types of data such as image data or sound-voice data, a solid-state drive (SSD) 105 configured to control reading or writing of various types of data with respect to the flash memory 104 in accordance with the control of the CPU 101, a medium drive 107 configured to control reading or writing of various types of data with respect to a medium 106 such as a flash memory or the like, an operations button 108 configured to be operated (by a user) for electing a destination of the terminal 10 or the like, a power switch 109 configured to switch ON or OFF of the power of the terminal 10, a network interface (I/F) 111, and an authentication receiving I/F 118 for performing data transmission using the later-described communications network 2.

The terminal 10 further includes a built-in camera 112 configured to image a subject to acquire image data in accordance with the control of the CPU 101, an imaging device I/F 113 configured to control the drive of the camera 112, a built-in microphone 114 configured to input sound and voice, a built-in speaker 115 configured to output sound and voice, a sound input-output I/F 116 configured to process input and output of sound and voice signals between the microphone 114 and the speaker 115 in accordance with the control of the CPU 101, a display I/F 117 configured to transmit image data to an externally attached display 120 in accordance with the control of the CPU 101, an external apparatus connecting I/F 181 for connecting various types of external apparatuses, an alarm lamp 119 configured to report abnormality of various functions of the terminal 10, and a bus line 110 such as an address bus or a data bus for electrically connecting the above-described components.

The terminal 10 may further include an NFC I/F 121 or a Bluetooth (registered trademark) I/F 122. The NFC I/F 121 is a communications interface compatible to one of the international standards called near field communications (NFC) standards such as ISO/IEC 18092 etc. for performing data communications by bringing two or more devices within a close distance of each other. The Bluetooth I/F 122 is a communications interface compatible to Bluetooth (IEEE 802.15.1 etc.) that is standardized in one of near field wireless communications technologies.

The display 120 is a display part formed of liquid crystal or organic EL (OLED), and is configured to display an image of the subject or operational icons. The display 120 is connected to the display I/F 117 via a cable 120c. The cable 120c may be an analog RGB (VGA) signal-specific cable, a component video-specific cable, a high-definition multimedia interface (HDMI) (registered trademark) or a DVI (digital video interactive) signal-specific cable.

The camera 112 includes lenses or a solid-state image sensor configured to convert an image (video) of a subject into electronic data by converting light waves into electric charges. Examples of the solid-state image sensor include a CMOS (complementary metal oxide semiconductor) and a CCD (charge coupled device).

The external apparatus connecting I/F 181 is configured to be connected via a universal serial bus (USB) to external apparatuses such as an external camera, an external microphone, and an external speaker. When the external camera is connected to the external apparatus connecting I/F 181, the external camera is driven in preference to the built-in camera 112 in accordance with the control of the CPU 101. Similarly, when the external microphone or the external speaker is connected to the external apparatus connecting I/F 181, the external microphone or the external speaker connected to the external apparatus connecting I/F 181 is driven in preference to a corresponding one of the built-in microphone 114 and the built-in speaker 115 in accordance with the control of the CPU 101.

Note that the recording medium 106 is configured to be removable from the terminal 10. When the recording medium 106 is formed of a nonvolatile memory configured to read or write data in accordance with the control of the CPU 101, the nonvolatile memory is not limited to the flash memory 104. The nonvolatile memory serving as the recording medium 106 may be an EEPROM (Electrically Erasable and Programmable ROM), or the like.

The above-described terminal-specific programs may be distributed in a form of a computer-readable recording medium (i.e., the recording medium 106, etc.) storing the programs in files of an installable format or executable format. Alternatively, the above-described terminal-specific programs may be stored in the ROM 102 instead of the flash memory 104.

General-Purpose Terminal

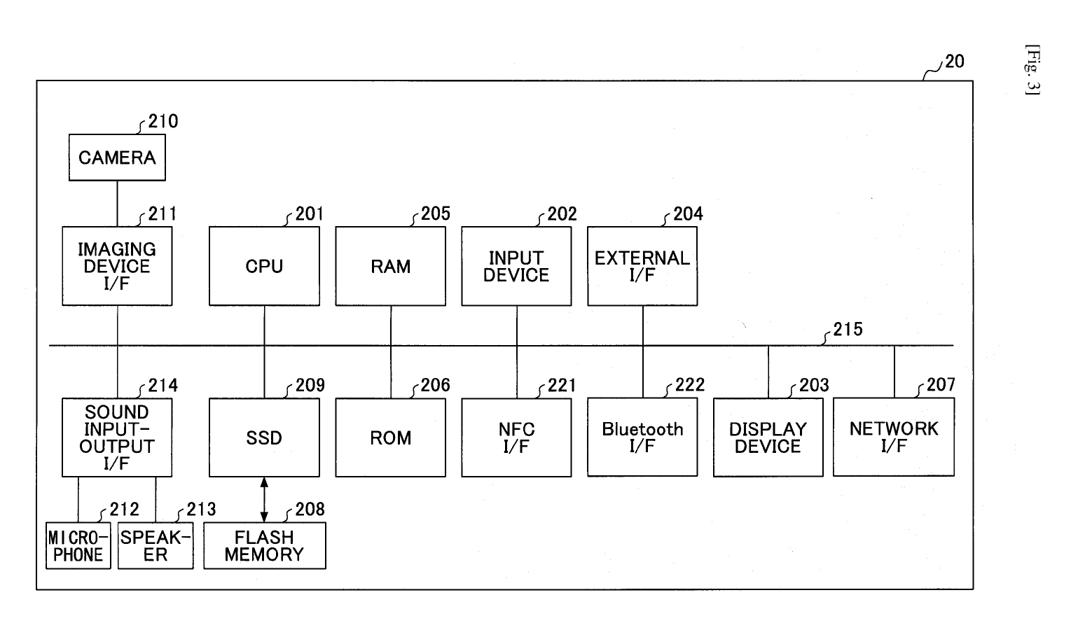

FIG. 3 is a hardware configuration diagram illustrating a general-purpose terminal 20.

As illustrated in FIG. 3, the terminal 20 according to the embodiment includes a CPU 201 configured to control overall operations of the terminal 20, an input device 202 configured to input various types of signals into the terminal 20, a display device 203 configured to display a process result obtained by the terminal 20, an external I/F 204 serving as an interface between various types of external apparatuses such as an external microphone, an external camera, and an external recording medium, and the terminal 20, a RAM 205 utilized as a work area of the CPU 201, a ROM 206 configured to store programs and data such as settings of the OS of the terminal 20 and network settings, a network I/F 207 configured to transmit data by utilizing a mobile phone communications network or the Internet, a flash memory 208 configured to store various types of data such as terminal-specific programs, and an SSD 209 configured to control reading or writing of various types of data with respect to the flash memory 208 in accordance with the control of the CPU 201.

The terminal 20 further includes a built-in camera 210 configured to image a subject to acquire image data in accordance with the control of the CPU 201, an imaging device I/F 211 configured to control driving of the camera 210, a built-in microphone 212 configured to input sound, a built-in speaker 213 configured to output sound, a sound input-output I/F 214 configured to input and output sound signals between the microphone 212 and the speaker 213 in accordance with the control of the CPU 201, and a bus line such as an address bus or a data bus configured to electrically connect the above-described components. Note that when the terminal 20 utilizes a text chat service alone, the terminal 20 is not necessarily provided with the camera 210, the microphone 212, the speaker 213, and the like.

The terminal 20 may further include one of or both of the NFC I/F 221 or a

Bluetooth I/F 222.

Further, when the terminal 20 includes a nonvolatile memory configured to read or write data in accordance with the control of the CPU 101, an EEPROM or the like may be used in place of the flash memory 208.

The above-described terminal-specific programs may be distributed in a form of a computer-readable recording medium, such as the recording medium, and the like storing the programs in files of an installable format or an executable format. Alternatively, the above-described terminal-specific programs may be stored in the ROM 206 instead of the flash memory 208.

Management System

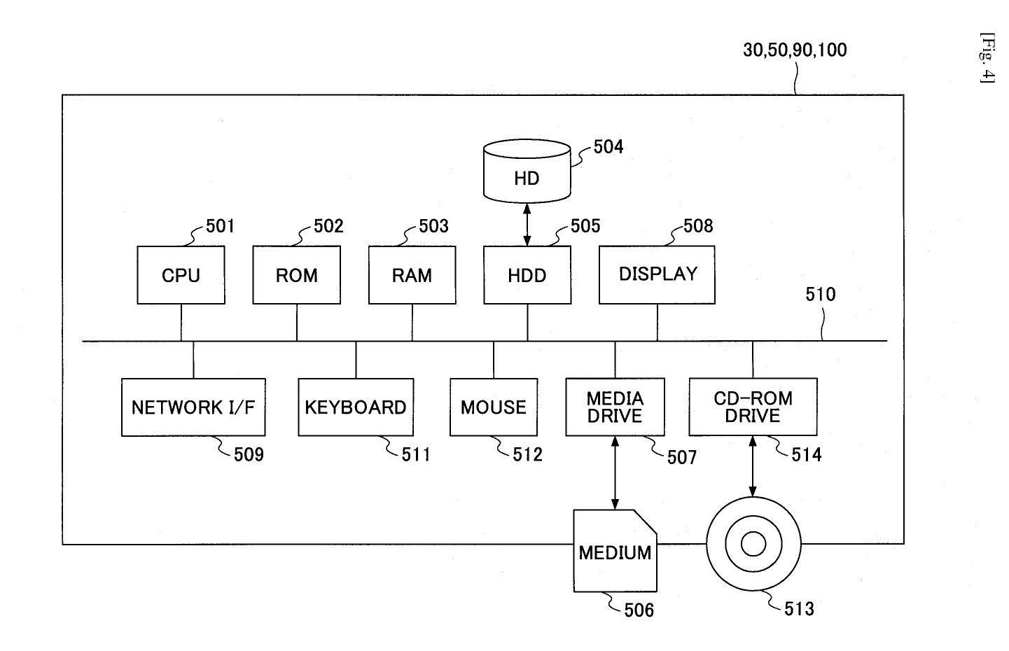

FIG. 4 is a hardware configuration diagram of the management system 50 according to an embodiment. The management system 50 includes a central processing unit (CPU) 501 configured to control overall operations of the management system 50, a read only memory (ROM) 502 configured to store transmission management-specific programs, a random access memory (RAM) 503 configured to serve as a work area of the CPU 503, a hard disk (HD) 504 configured to store various types of data in accordance with the control of the CPU 501, a hard disk drive (HDD) 505 configured to control reading or writing of various types of data with respect to the HD 504 in accordance with the control of the CPU 501, a medium drive 507 configured to control reading or writing (storing) of data with respect to a medium 506 such as a flash memory or the like, a display 508 configured to display various types of information such as a cursor, menus, windows, characters, or images, a network I/F 509 configured to perform data transmission using a later-described communications network 2, a keyboard 511 provided with plural keys for inputting characters, numeric values, various types of instructions, and the like, a mouse 512 configured to select and execute various types of instructions, select a process target, and move a cursor, a CD-ROM drive 514 configured to control reading or writing of data with respect to a compact disk read only memory (CD-ROM) 513 as an example of a removable recording medium, and a bus line 510 such as an address bus or a data bus for electrically connecting the above-described components.

Note that the above-described transmission management-specific programs may be distributed in a form of the above-described computer-readable recording medium 506, CD-ROM 513 and the like storing the programs in files of an installable format or executable format.

The relay apparatus 30 has a hardware configuration similar to that of the management system 50, and hence, a duplicated illustration of the relay apparatus 30 is omitted from the specification. Note that the ROM 502 in the relay apparatus 30 is configured to store relay apparatus-specific programs for controlling the relay apparatus 30. In this case, the relay apparatus-specific programs may be distributed in a form of the above-described computer-readable recording medium 506, CD-ROM 213 and the like storing the programs in files of an installable format or executable format.

The program providing system 90 also has a hardware configuration similar to that of the management system 50, and hence, a duplicated illustration of the program providing system 90 is omitted from the specification. Note that the ROM 502 in the program providing system 90 is configured to store program providing-specific programs for controlling the program providing system 90. In this case, the program providing-specific programs may also be distributed in a form of the above-described computer-readable recording medium 506, CD-ROM 213 and the like storing the programs in files of an installable format or executable format.

The maintenance system 100 has a hardware configuration similar to that of the management system 50, and hence, a duplicated illustration of the maintenance system 100 is omitted from the specification. Note that the ROM 502 in the maintenance system 100 is configured to store maintenance-specific programs for controlling the maintenance system 100. In this case, the maintenance-specific programs may also be distributed in a form of the above-described computer-readable recording medium 506, CD-ROM 213 and the like storing the programs in files of an installable format or executable format.

Note that other examples of the removable computer-readable recording medium include a compact disc recordable (CD-R), a digital versatile disk (DVD), a Blu-ray Disc, and the like, which records the above-described various types of programs for the components of the management system 50 to be ready for distribution.

Functional Configurations of Embodiment

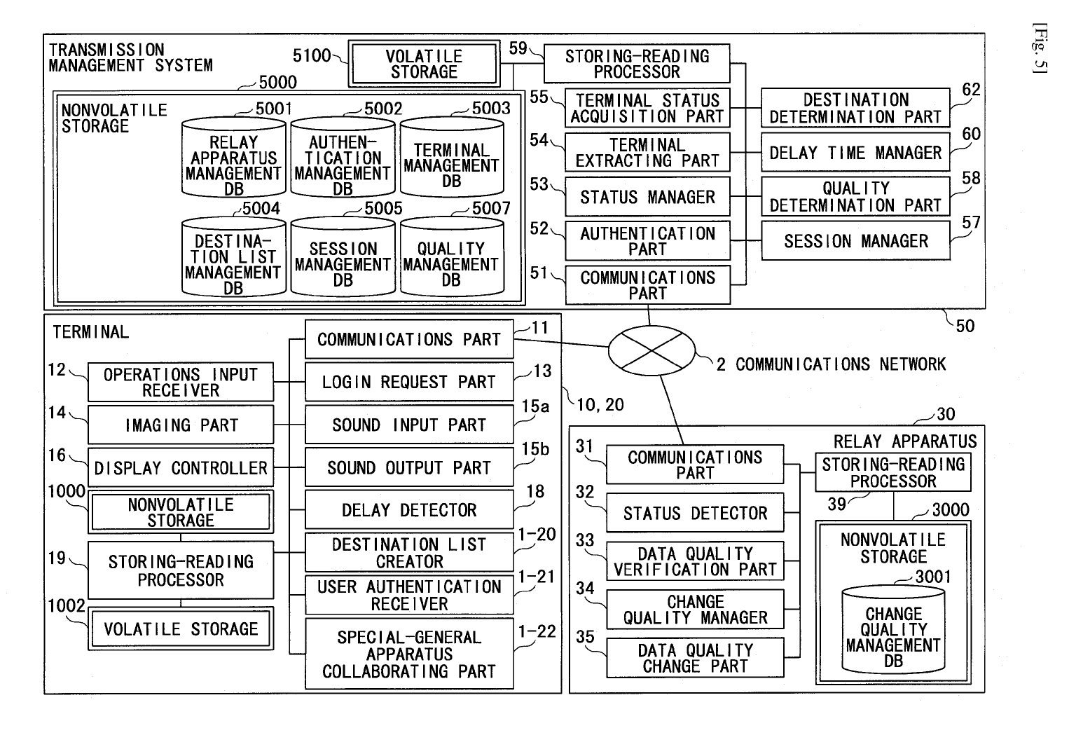

The following describes functional configurations of the embodiment. FIG. 5 is a functional block diagram illustrating the terminals 10 and 20, the relay apparatus 30, and the management system 50 constituting the transmission system 1 according to the embodiment. As illustrated in FIG. 5, the terminals 10 and 20, the relay apparatus 30, and the management system 50 are connected via the communications network 2 to perform data communications with one another. Note that the program providing system 90 and the maintenance system 100 are not directly related to the communications for use in the TV conference, and an illustration of the program providing system 90 and the maintenance system 100 is therefore omitted from FIG. 5.

Functional Configuration of Each Terminal

The terminals 10 and 20 each include a communications part 11, an operations input receiver 12, a login request part 13, an imager 14, a sound-voice input part 15a, a sound-voice output part 15b, a display controller 16, a delay detector 18, a storing-reading processor 19, a destination list creator 1-20, a user authentication receiver 1-21, and a special-general apparatus collaborating part 1-22. These components are functional components or functional parts implemented by causing any one of the components illustrated in FIG. 2 or 3 to operate instructions from the CPU 101 or 201 in accordance with the operations part programs stored in the program ROM 102 or 206. The terminals 10 and 20 each further include a volatile storage 1002 formed of the RAM 103 or 205, and a nonvolatile storage 1000 formed of flash memory 104 or 208.

Functional Components of Each Terminal

The following describes details of components of the terminals 10 and 20. The communications part 11 of the terminal 10 or 20 is implemented by the network I/F 111 or 207 illustrated in FIG. 2 or 3, and is configured to perform transmission and receipt of various types of data (or information) with other terminals, apparatuses, or systems via the communications network 2.

The communications part 11 starts receiving status information of the terminal 10 or 20 as destination terminal candidates from the management system 50 before the terminal 10 or 20 establishes a session with another terminal 10 or 20 to start the TV conference by call communications.

Note that the destination terminal candidates refer to the terminals 10 or 20 that may be specified by an initiating terminal 10 or 20 as partners, that is, session partners with which the initiating terminal 10 or 20 performs the TV conference. That is, the initiating terminal 10 or 20 may fail to establish sessions with those terminals that are not set as the destination terminal candidates in advance, and the initiating terminal 10 or 20 thus is not able to hold a TV conference with those terminals. The destination terminal candidates are candidates as partner terminals with which the initiating terminal 10 or 20 holds a TV conference, namely, partner terminal candidates.

The status information indicates an operating status (an online status or an offline status) of each terminal 10 or 20, and when the terminal 10 or 20 is online (online-status), the status information further indicates a detailed status in the online status; that is, whether the line is busy or is in a standby mode (waiting) (hereinafter called a “communications status”) when the terminal 10 or 20 is in the online status. The status information further indicates various statuses other than the operating status and the communications status of each terminal 10 or 20, such as statuses in which a cable is disconnected from the terminal 10 or 20, sound-voice is capable of being output but images are incapable of being output, sound-voice output is set as being disabled (MUTE), and the like. The following illustrates an example of the status information including the operating status and the communications status.

When the initiating terminal 10 or 20 operates as a start request terminal, the communications part 11 transmits start request information to the management system 50. Note that the start request information serves as information that requests starting a session for use in a TV conference. The start request information specifically includes information indicating a request for initiating a TV conference, a terminal ID of the start request terminal serving as a transmission source of the start request information, and a terminal ID that identifies a destination terminal serving as a session partner. Note that the terminal ID is information for identifying the terminal 10 or 20.

The user authentication receiver 1-21 is configured to receive authentication information of a user input via the authentication receiving I/F 118.

The operations input receiver 12 includes an operations button 108 and a power switch 109, and is configured to receive various types of inputs from a user. For example, when the user switches the power switch 109 ON, the operations input receiver 12 receives the power ON to turn the power the terminal 10 or 20 ON.

The login request part 13 is implemented by instructions from the CPU 101 or 201, and is configured to transmit login request information representing an indication to request logging in, and a current IP address of the terminal 10 or 20 from the communications part 11 to the management system 50 via the communications network 101, which is triggered by the receipt of the power ON instruction. Further, when the user switches the power switch 109 from the ON-status to an OFF-status, the operations input receiver 12 completely switches the power OFF after the communications part 11 transmits the status information representing an indication to switch the power OFF. Hence, the management system 50 may be able to detect a change from the power ON status to the power OFF status of the power status of the terminal 10 or 20 .

The imager 14 is implemented by instructions from the CPU 101 or 201, a camera 113 or 210 and an imaging device I/F 113 or 211, and is configured to image a subject to output image data of the subject. The sound-voice input part 15a is implemented by instructions from the CPU 101 or 201, and the sound input-output I/F 116 or 214, and is configured to input sound-voice data associated with sound-voice signals when sound and voice of the user are converted by the microphone 114 or 212 into the sound-voice signals. The sound output part 15b is implemented by the instructions from the CPU 101 or 201, and the sound input-output I/F 116 or 214, and is configured to output the sound signals associated with the sound data to the speaker 115 or 213 to cause the speaker 115 or 213 to output sound and voice.

The display controller 16 is implemented by the display I/F 117 or the like, and is configured to control transmission of image data with respect to an externally attached display 120 or a display device 203. Before the terminal 10 or 20 serving as a request source starts communications of the TV conference with a desired destination terminal 10 or 20, the display controller 16 causes the display 120 or the display device 203 to display a destination list including destination names that reflect status information received after the communications part 11 starts receiving the image data.

The delay detector 18 is implemented by instructions from the CPU 101 or 201, and is configured to detect delay time (ms) of image data or sound-voice data transmitted from another terminal 10 or 20 via the relay apparatus 30.

The storing-reading processor 19 is implemented by instructions from the CPU 101 or 201, and the SSD 105 or 209 as an example, and is configured to store various types of data in the nonvolatile storage 1000, and read various types of data from the non-volatile storage 1000. The nonvolatile storage 1000 stores terminal IDs (identification) for identifying the terminals 10 or 20, associated passwords, and the like. The storing-reading processor 19 stores various types of data in the volatile storage 1002 or reads various types of data from the volatile storage 1002. The volatile storage 1002 stores content data received when the terminal 10 performs communications with the destination terminal, and overwrites the stored content data every time the volatile storage 1002 receives the content data. Among these data, images based on the image data before being overwritten are displayed by the display 120 or the display device 203, and sounds based on the sound data before being overwritten are output by the speaker 115 or 213.

The destination list creator 1-20 is configured to create and update an address list indicating statuses of the destination candidates with icons, based on the later-described destination list information and the status information of the terminals 10 or 20 serving as the later-described destination candidates.

The destination list creator 1-20 in this embodiment specifically generates the destination list relating to the corresponding user from the destination list information of the user under the following conditions; where the terminal 10 or 20 is in a login state in the transmission management system 50, the display 120 or the like displays the destination list relating to the terminal 10 or 20, the user who uses the terminal 10 or 20 inputs authentication information via the authentication receiving OF 118, and receives the destination list information based on the user from the transmission management system 50. The display controller 16 updates the destination list relating to the terminal 10 or 20 displayed on the display 120 or the like with a newly created destination list relating to the user.

Further, the destination list creator 1-20 generates the destination list relating to another user from the destination list information of this user under the following conditions; where the user is in a login state in the transmission management system 50, the display 120 or the like displays the destination list based on the user, a different user who uses the terminal 10 or 20 inputs authentication information via the authentication receiving I/F 118, and receives the destination list information based on the different user from the transmission management system 50. The display controller 16 updates the destination list relating to the former user displayed on the display 120 or the like with a newly created destination list relating to the latter (different) user.

The special-general apparatus collaborating part 1-22 is configured to control a process associated with collaboration between the special-purpose apparatus of the terminal 10 and the general-purpose apparatus of the terminal 20. More specifically, the special-general apparatus collaborating part 1-22 associates the terminal 20 with one of the terminals 10 in advance (pairing) by the user's operations, and when the terminal 20 receives an incoming call from a counterpart terminal 10, the special-general apparatus collaborating part 1-22 performs control to start a TV conference on the terminal 10 based on the instructions from the terminal 20. Further, the special-general apparatus collaborating part 1-22 associates the terminal 20 with one of the terminals 10 by the user's operations when receiving an outgoing call based on the destination list (address book) from the terminal 20, and performs control to cause the terminal 10 to transmit the outgoing call to a counterpart terminal to start a TV conference.

The general-purpose apparatus may also perform a TV conference by transmitting the outgoing call or receiving the incoming call in a manner similar to the special-purpose apparatus; however, the use of the special-purpose apparatuses may still be advantageous in terms of performance of cameras, displays, speakers and the like. A substantial number of users may desire to use the special-purpose apparatuses to conduct the TV conference or the like when the special-purpose apparatuses are disposed nearby. The use of the individual accounts to operate the special-purpose apparatus is generally susceptible to risk of exposing the destination lists of the individuals to a third party or may allow a third party to perform unauthorized operations using the individual accounts of the users when the users are away from their seats. However, the above-described collaboration between the special-purpose apparatus and the general-purpose apparatus enables the user to operate the special-purpose apparatus using the individual accounts of the users to perform a TV conference with high security.

Functional Configuration of Relay Apparatus

Next, an illustration is given of functions and processes performed by the relay apparatus 30. The relay apparatus 30 includes a communications part 31, a status detector 32, a data quality verification part 33, a change quality manager 34, a data quality change part 35, and a reading-storing processor 39. These components are functional components or functional parts implemented by causing any one of the components illustrated in FIG. 4 to operate instructions from the CPU 402 in accordance with the operations part programs stored in the ROM 502. The relay apparatus 30 is composed of the HD 504, and includes a nonvolatile storage 3000 capable of maintaining various types of data and information even though the power of the relay apparatus 30 is switched OFF.

The nonvolatile storage 3000 includes a change quality management database (DB) 3001 composed of a change quality management table. Note that the change quality management table is configured to manage IP addresses of the terminals 10 or 20 as relay destinations of relaying the image data in association with an image quality of the image data relayed by the relay apparatus 30 to the relay destinations.

Functional Components of Relay Apparatus

The following describes functional configurations of the relay apparatus 30. Note that in the following, an illustration is also given of a relationship with main components for implementing the functions of the relay apparatus 30.

The communications part 31 of the relay apparatus 30 is implemented by the network I/F 509, and is configured to perform transmission and receipt of various types of data (or information) with other terminals, apparatuses, or systems via the communications network 2. The status detector 32 is implemented by instructions from the CPU 501, and is configured to detect an operating status of the relay apparatus 30 having the status detector 32. The operating status includes an “online” status, an “offline” status, and a “failure” status.

The data quality verification part 33 is implemented by instructions from the CPU 501, and is configured to search the change quality management table by the IP address of the destination terminal as a search key and extract the image quality of the corresponding relaying image data to verify the image quality of the relaying image data. The change quality manager 34 is implemented by instructions from the CPU 501, and is configured to change content of the change quality management table of the change quality management DB 3001, based on the later-described quality information transmitted from the management system 50.

The data quality change part 35 is implemented by instructions from the CPU 501, and is configured to change the image quality of the image data transmitted from the terminal 10 or 20 serving as a transmission source based on the content of the change quality management table of the change quality management DB 3001. The storing-reading processor 39 is implemented by the HDD 505, and is configured to store various types of data in the nonvolatile storage 3000, and read various types of data from the nonvolatile storage 3000.

Functional Configuration of Management System

The following describes functions and processes performed by the management system 50. The management system 50 includes a communications part 51, an authentication part 52, a status manager 53, a terminal extracting part 54, a terminal status acquisition part 55, a session manager 57, a quality determination part 58, a storing-reading processor 59, a delay time manager 60, and a destination determination part 62. These components are functional components or functional parts implemented by causing any one of the components illustrated in FIG. 4 to operate instructions from the CPU 501 in accordance with the operations part programs stored in the program ROM 502. The transmission management system 50 includes a nonvolatile storage 5000 composed of the HD 504 capable of maintaining various types of data and information even though the power of the transmission management system 50 is switched OFF. The nonvolatile storage 5000 is configured to store various types of information. The transmission management system 50 further includes a volatile storage 5100 composed of the RAM 503 illustrated in FIG. 503.

Relay Apparatus Management Table

The nonvolatile storage 5000 includes the relay apparatus management DB 5001 composed of the relay apparatus management table. The relay apparatus management table is configured to manage operating statuses of the relay apparatuses 30, received dates and times of the status information indicating the operating statuses received by the management system 50, IP addresses of the relay apparatuses 30, and the maximum data transmission rates (Mbps) of the relay apparatuses 30 in association with respective relay apparatus IDs identifying the relay apparatuses 30.

Authentication Management Table

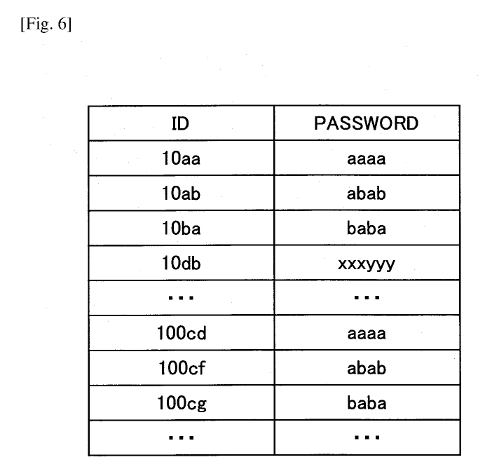

The nonvolatile storage 5000 further includes an authentication management DB 5002 composed of an authentication management table illustrated in FIG. 6. The authentication management table is configured to manage the terminal IDs of all the terminals 10 and 20, or the user IDs of all the users who use the terminals 10 and 20 in association with respective passwords. The terminal IDs are information for identifying the terminals 10 and 20, and the user IDs are information for identifying the users. The passwords are information used for authenticating the terminals 10 and 20 or the users. Note that the terminal ID and the user ID may be generically called an ID. In the authentication management table illustrated in FIG. 6, a password for the terminal ID “10aa” of the terminal or the user is “aaaa”.

The IDs of the embodiment indicate identification information such as a language, characters, symbols, or various types of marks used for uniquely identifying each transmission terminal 10 or 20, or a user of the transmission terminal 10 or 20. Further, the ID may be identification information composed of a combination of at least two of the above language, characters, symbols, and marks. The terminal ID may include identification information for identifying a user.

Terminal Management Table

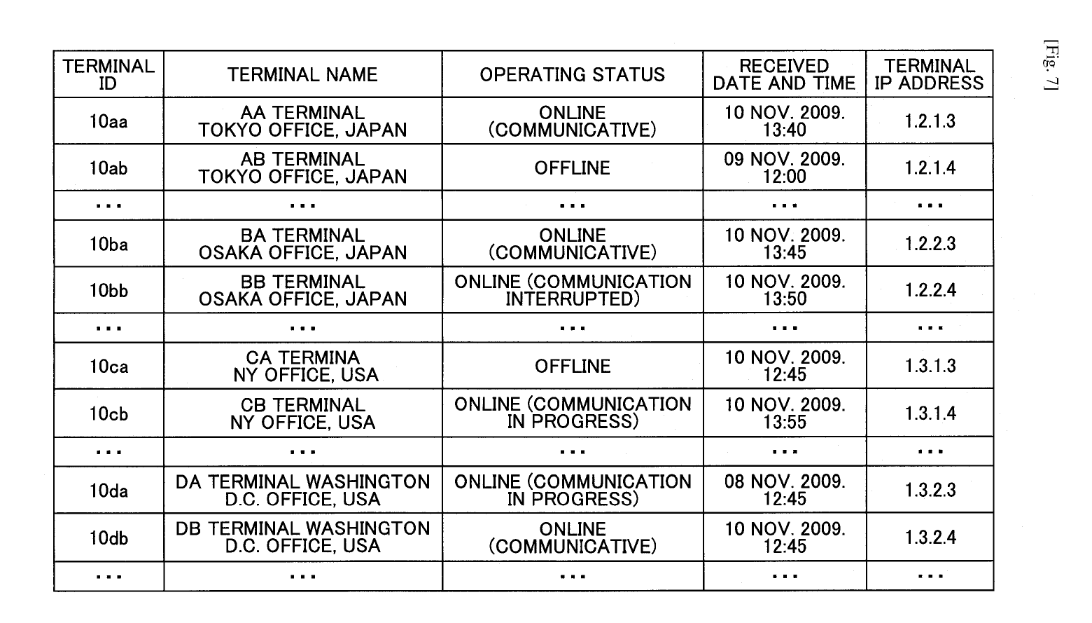

The nonvolatile storage 5000 includes a terminal management DB 5003 composed of a terminal management table illustrated in FIG. 7. The terminal management table is configured to manage the terminal names, the operating statuses of the terminals 10 and 20, date and time of the later-described login request information received by the transmission management system 50, and the IP addresses of the terminals 10 and 20 in association with the terminal IDs of the terminals 10 and 20.

Note that the operating status includes an online status in which the power is switched on and the terminal is in a standby mode capable of performing communications or in a busy mode currently performing communications, and an offline status in which the power is not switched on to indicate that the terminal is not in the standby mode incapable of performing communications. In the terminal management table illustrated in FIG. 7, the terminal 10aa having the terminal ID “10aa” has the terminal name of “AA Terminal, Tokyo Office, Japan”, the operating status of “Online”, the date and time at which the management system 50 has received the login request information of “10 Nov. 2009. 13:40” (i.e., Nov. 10, 2009, 13:40), and the IP address of the terminal 10aa of “1.2.1.3”.

Destination List Management Table

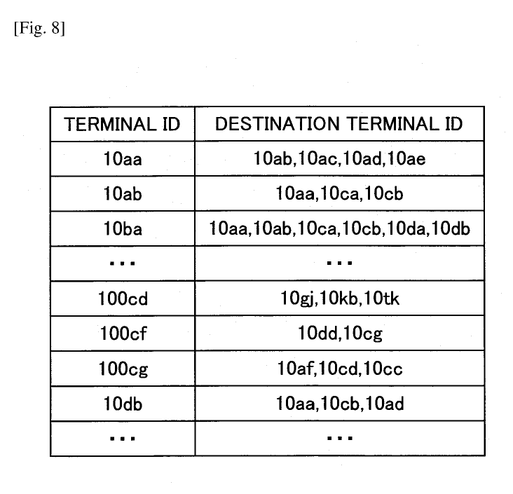

The nonvolatile storage 5000 further includes a destination list management DB 5004 composed of a destination list management table illustrated in FIG. 8. The destination list management table is configured to manage start request terminal IDs of the terminals 10 and 20 serving as request sources of the session start request information for use in the TV conference including call communications managed by the management system 50 in association with the terminal IDs of the terminals 10 and 20 identifying destination terminal candidates serving as destination candidates to which content data are transmitted from the request source terminals 10 and 20, or IDs such as user IDs and the like of the terminals 10 and 20. As illustrated in the destination list management table illustrated in FIG. 8, destination terminal candidates to which a terminal (a terminal 10aa) having the terminal ID “10aa” is capable of transmitting a TV conference start request are, for example, a terminal 10ab having the terminal ID “10ab”, a terminal 10ac having the terminal ID “10ac”, a terminal 10ad having the terminal ID “10ad”, and a terminal 10ae having the terminal ID “10ae”. These destination terminal candidates in the destination list management table may be updated by transmitting an addition request or a deletion request from the start request terminal to the management system 50.

Session Management Table

The nonvolatile storage 5000 further includes a session management DB 5005 composed of a session management table. The session management table is configured to manage the relay apparatus IDs for use in relaying content data in the respective sessions, the terminal IDs of start request terminals serving as transmission sources of the session start request information, the terminal IDs of the destination terminals specified as communication counterparts in the session start information, delay times (ms) in receiving the image data in the destination terminals, and received dates and times at which the management system 50 has received delay information including delay times transmitted from the destination terminals in association with the respective session IDs for identifying different sessions for transmitting content data between the terminals.

Quality Management Table

The nonvolatile storage 5000 includes a quality management DB 5007 composed of a quality management table. The quality management table is configured to manage the image quality (the quality of an image) of the image data relayed by the relay apparatus 30 based on the delay times (ms) of the image data in the start request terminals or the destination terminals.

Functional Components of Management System

The following describes detailed functional components of the management system 50. Note that in the following, an illustration is also given of a relationship with main components illustrated in FIG. 4 for implementing the functions of the management system 50.

The communications part 51 is implemented by the network I/F 509, and is configured to perform transmission and receipt of various types of data (or information) with other terminals, apparatuses, or systems via the communications network 2. The authentication part 52 searches the authentication management table of the nonvolatile storage 5000 by the terminal ID or the user ID, and its corresponding password included in the login request information received via the communications part 51 as a search key, and authenticates the terminal 10 or 20, or the user based on the determination as to whether the identical terminal ID (or the user ID) and its corresponding password are managed in the authentication management table.

The status manager 53 is configured to manage an operating status of a terminal management table. The status manager 53 is configured to manage the operating statuses of the login requested terminals 10 or 20 (the login request terminals) in the terminal management table to store the terminal IDs of the login request terminals 10 or 20 in association with the operating statuses of these login request terminals 10 or 20, received dates and times at which the management system 50 has received the login request information, and the IP addresses of the login request terminals 10 or 20. When the user of the terminal 10 or 20 switches the power switch 109 of the terminal 10 or 20 from an OFF status to ON status to transmit information indicating the power of the terminal 10 or 20 to be turned ON, the status manager 53 receives the power ON information from the terminal 10 or 20, and sets the operating status indicating “offline” in the terminal management table into “online”, based on the received power ON information transmitted from the terminal 10 or 20. When the user of the terminal 10 switches the power switch 109 of the terminal 10 or 20 from an ON status to OFF status to transmit information indicating the power of the terminal 10 or 20 to be turned OFF, the status manager 53 receives the power OFF information from the terminal 10 or 20, and sets the operating status indicating “online” in the terminal management table into “offline”, based on the received power OFF information transmitted from the terminal 10 or 20.

When the communications part 51 receives the change request information transmitted by the start request terminal or the destination terminal in the TV conference start request information, the status manager 53 appropriately changes the operating status of at least one of the start request terminal and the destination terminal in the terminal management table.

The terminal extracting part 54 is configured to search the destination list management table by an ID, that is, the terminal ID of a target terminal subjected to processing such as the login request terminal 10 or 20, or the user ID of the user as a search key, to read the terminal IDs of the destination terminal candidates capable of communicating with the target terminal, that is, the terminal IDs of the destination terminal candidates with which the target terminal 10 may establish a session, and to extract the terminal IDs of the destination terminal candidates capable of communicating with the target terminal. Specifically, the terminal extracting part 54 reads the terminal ID of the destination terminal candidate in association with the terminal ID of the start request terminal that matches the terminal ID of the target terminal.

The terminal extracting part 54 searches the destination list management table by the terminal ID of the target terminal as a key to extract the terminal IDs of other terminals 10 and 20 that have registered the terminal ID of the target terminal as a destination terminal candidate. Specifically, the terminal extracting part 54 reads from the destination list management table the terminal ID of the start request terminal in association with the terminal ID of the destination terminal candidate that matches the terminal ID of the target terminal.

The terminal status acquisition part 55 searches the terminal management table by the ID as a search key to read the operating status for each of IDs. The terminal status acquisition part 55 may thus be able to acquire the operating status of the destination terminal candidate capable of communicating with the login request terminal 10 or 20. The terminal status acquisition part 55 also searches the terminal management table to acquire the operating status of the login request terminal.

The session management part 57 is configured to manage the session management table of the nonvolatile storage 5000 to store the session IDs generated by a session ID generator in association with the terminal IDs of the request source terminals, and the terminal IDs of the destination terminals. The session manager 57 also manages the session IDs stored in the session management table in association with the relay apparatus ID of one of the relay apparatuses 30 finally selected for each of the session IDs.

The quality determination part 58 is configured to search the quality management table by the delay time as a search key to extract the image quality of the corresponding image data to determine the image quality of the image data to be relayed by the relay apparatus 30. The storing-reading processor 59 is implemented by the HDD 505, and is configured to store various types of data in the nonvolatile storage 5000, and read various types of data from the nonvolatile storage 5000. The storing-reading processor 59 further stores various types of data in the volatile storage 5100 or reads various types of data from the volatile storage 5100.

The delay time management part 60 is configured to manage delay time indicated in the delay information by searching the terminal management table by the IP address of the above destination terminal as a search key to extract the terminal ID corresponding to the IP address of the destination terminal, and further storing a delay time indicated in the delay information in a field part of the delay time in the record that includes the extracted terminal ID in the session management table.

The destination determination part 62 is configured to refer to the destination list management table and determine whether the destination terminal ID of the terminal 10 or 20 that attends content data session extracted by the terminal extracting part 54 includes the destination terminal ID of the attendance request terminal 10 or 20.

Operations

Activation of Terminal

FIG. 9 is a sequence diagram illustrating a process example upon activation of a terminal. FIG. 9 mainly illustrates a process upon activation of the special-purpose apparatus that is a common client terminal.

As illustrated in FIG. 9, when a user switches the power button ON of a terminal 01ab to activate the terminal 01ab (step S001), the terminal 01ab performs an activation process (step S002).

The terminal 01ab subsequently transmits a authentication request based on a common account set in advance in the transmission management system 50 (step S003). The transmission management system 50 then performs terminal authentication (step S004), and transmits a response of an authentication result to the terminal 01ab (step S005).

When the authentication is performed normally, the terminal 01ab subsequently transmits a destination list request to the transmission management system 50 (step S006), and the transmission management system 50 transmits a destination list (step S007). The terminal 01ab subsequently displays the destination list on a screen (step S008). The transmission management system 50 transmits a status report to another terminal 01ba (step S009).

When the user performs a login operation or the like by presenting (using) identification information of his or her individual account to the terminal 01ab (step S010), the terminal 01ab transmits a user authentication request to the transmission management system 50 (step S011). Note that the user may also allow to use the system without a login process by presenting an effective user identification information, in addition to performing the login operation by presenting the user identification information.

Upon receipt of the user authentication request, the transmission management system 50 performs user authentication (step S012), and subsequently transmits a response of an authentication result to the terminal 01ab (step S013). The transmission management system 50 also transmits a status report of the user to another terminal 01ba (step S014).

On the other hand, the general-purpose apparatus that is an individual client terminal does not have steps S001 to S009. The individual client terminal only has steps S010 to S014.

Note that the following illustration simplifies the activation process of the terminal because details of the process have already described with reference to FIG. 9.

Pairing

A pairing process is processed performed in advance in the following case. The user who uses an individual client terminal with the individual account desires to use the individual client terminal until responding to an incoming call addressed to the individual account from a counterpart (transmission source), and use, after responding to the incoming call, a common client terminal to perform a TV conference with the counterpart.

Individual Client Terminal Acquires Information from Common Client

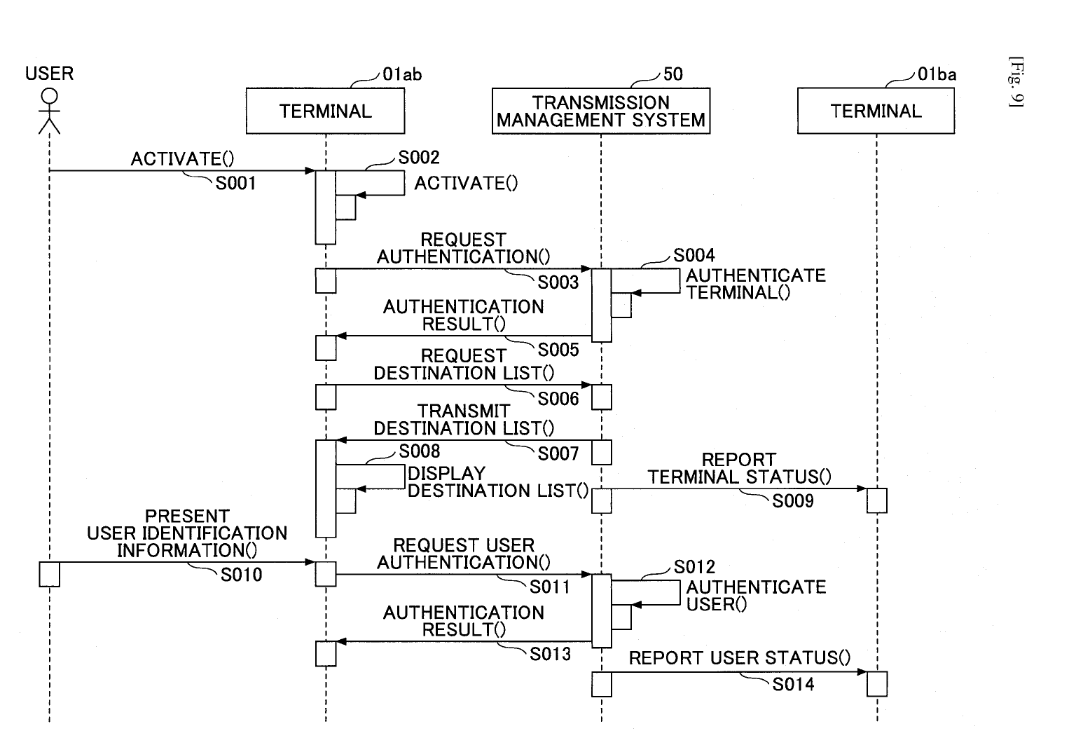

FIG. 10 is a sequence diagram illustrating a process example of pairing. FIG. 10 illustrates a process example of collaborating an individual client terminal and a common client terminal using a two-dimensional code (hereinafter abbreviated as “2D code”) such as QR code (registered trademark).

As illustrated in FIG. 10, when the common client terminal is activated (step S101), the common client terminal logs in with a common account in the activating process to display a destination list relating to the common client terminal.

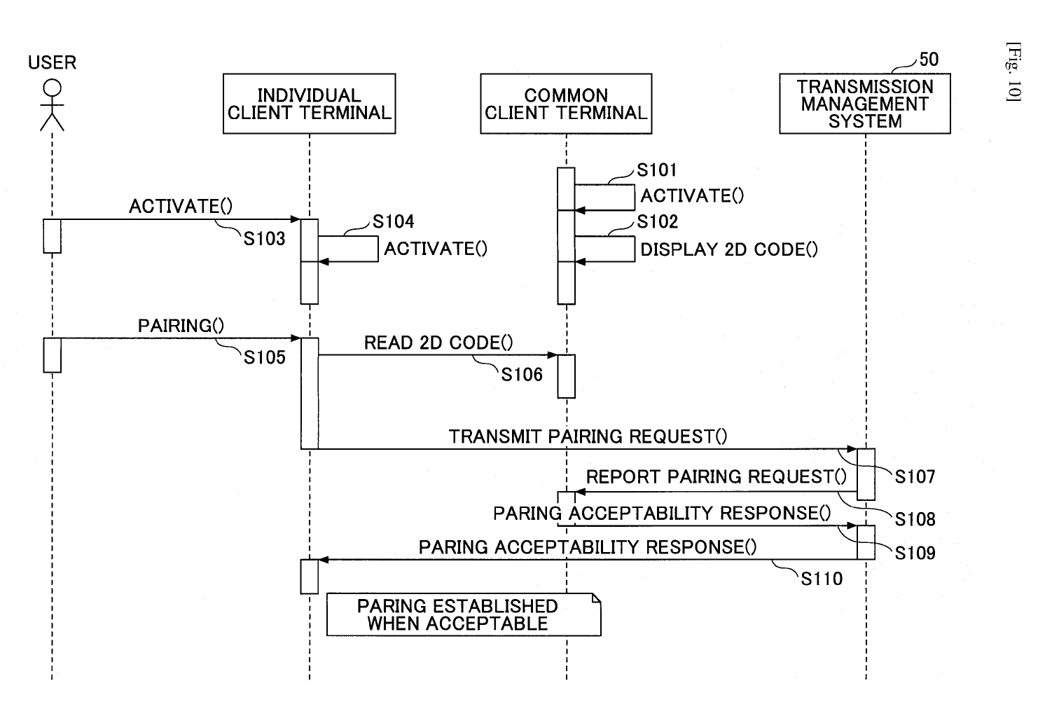

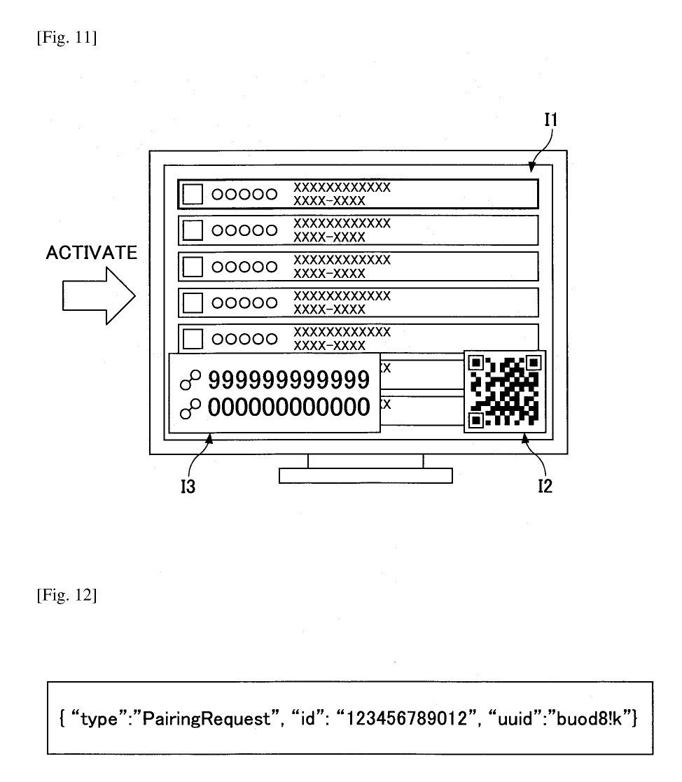

The common client terminal also displays a 2D code including information that specifies an own terminal (the common client terminal) (step S102). FIG. 11 illustrates an example of the common client terminal that displays a destination list I1 and 2D code I2 on a screen. The common client terminal may also display on the screen an ID list I3 of individual client terminals that are currently paired with the common client terminal.

FIG. 12 illustrates an example of data embedded in the 2D code, which includes “type”, “id”, and “uuid”. The “type” indicates a type of a message, with which “PairingRequest” is set, which facilitates returning the read message as it is as a pairing request. The “id” is information that specifies the common client terminal. The “id” is used as a destination (address) of the common client terminal to which the individual client terminal transmits a message. The “uuid” sets a randomized character string for preventing the reuse of 2D code. Such a randomized character string is transmitted together with transmission of the message from the individual client terminal to the common client terminal, and the common client terminal subsequently verifies whether the transmitted character string matches the latest one, thereby preventing the reuse of 2D code. A further limitation such as expiration data may be added to the character string to secure the validity of the pairing. The 2D code may also include a public key for use in encrypting a message transmitted from the individual client terminal.

Referring back to FIG. 10, when the user activates an individual client terminal (step S103), the individual client terminal logs in with an individual account in the activating process to display a destination list relating to the individual client terminal (step S104).

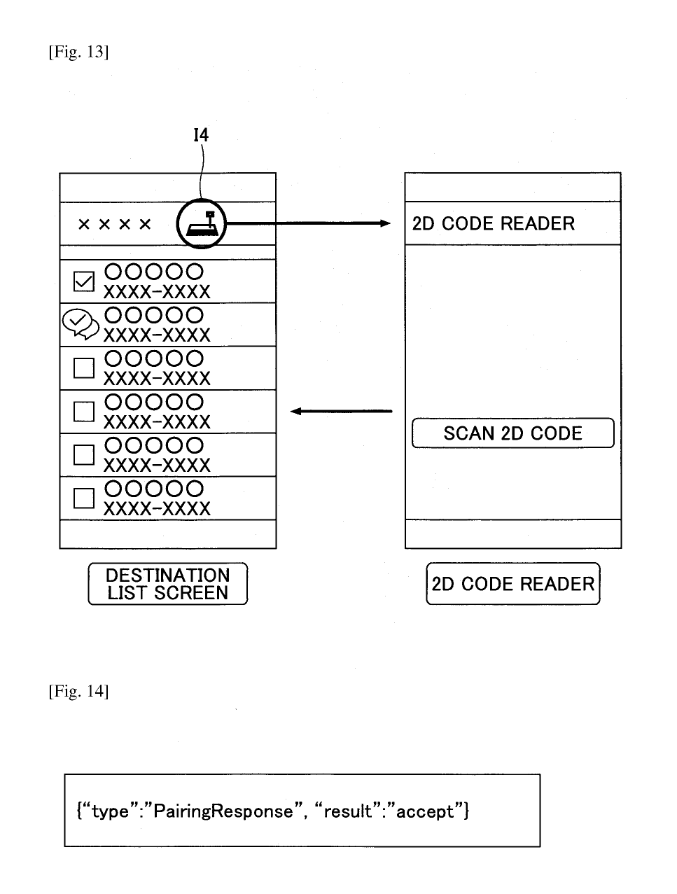

When the user subsequently performs an operation to start pairing with the common client terminal (step S105), the individual client terminal activates a 2D code reader to read a 2D code on a screen of the common client terminal (step S106). FIG. 13 is a diagram illustrating an operation example of starting a pairing process. A 2D code reader screen is displayed when the user taps a common client terminal icon 14 on a destination list screen.

Referring back to FIG. 10, the individual client terminal transmits a pairing request to the transmission management system 50 based on content of the read 2D code (step S107). Upon receipt of the pairing request, the transmission management system 50 reports (or transmits a report of) the pairing request to a corresponding (specified) one of the common client terminals based on common client terminal specifying information included in the pairing request (step S108).

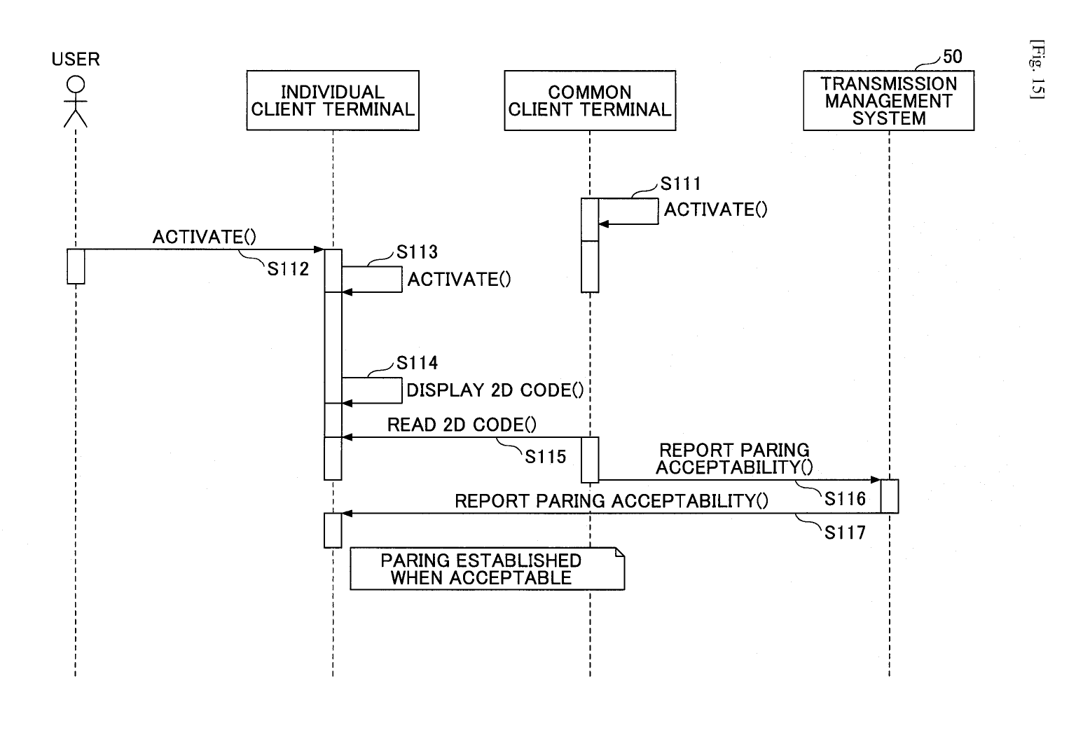

When the common client terminal that has received the report of the pairing request allows the pairing unconditionally, the common client terminal performs no operations, and subsequently transmits a response of acceptability of the pairing to the individual client terminal via the transmission management system 50 (steps S109 and S110). On the other hand, when the randomized character string needs to be verified, the common client terminal that has received the report of the pairing request verifies the validity of the randomized character string, and subsequently transmits a response of acceptability of the pairing to the individual client terminal via the transmission management system 50 (steps S109 and S110). FIG. 14 is a diagram illustrating an example of pairing acceptability response data, which include a type “PairingResponse”, and a result “accept”.

When the pairing is acceptable (the result “accept”), the pairing is established, and the individual client terminal and the common client terminal mutually hold their paired counterparts' information. Note the once established pairing may be cancelled based on the user's operation.

Note that the above example has illustrated information being exchanged via the 2D code such as QR code; however, information may be exchanged via one-dimensional code (barcode), pattern recognition, action recognition, or the like.

The above example has also illustrated the communications between the individual client terminal and the common client terminal being performed via the transmission management system 50 used for control the TV conference; however, an independent system for message exchange may be prepared to perform such communications.

Common Client Terminal Acquires Information from Individual Client Terminal to Perform Pairing Process Via Management System (Display 2-D Code on Individual Client Terminal

FIG. 15 is a sequence diagram illustrating another process example of pairing. This example differs from the example of FIG. 10 in that the 2D code is displayed on the individual client terminal.

As illustrated in FIG. 15, when the common client terminal is activated (step S111), the common client terminal logs in with a common account in the activating process to display a destination list relating to the common client terminal.

When the user activates an individual client terminal (step S112), the individual client terminal logs in with an individual account in the activating process to display a destination list relating to the individual client terminal (step S113). The individual client terminal also displays a 2D code including information that specifies the own terminal (the individual client terminal) (step S114).

The common client terminal subsequently activates a 2D code reader to read the 2D code on a screen of the individual client terminal (step S115), determines the pairing acceptability based on the read 2D code, and transmits (reports) a report of pairing acceptability result to the individual client terminal via the transmission management system 50 (steps S116 and S117). When the pairing is acceptable, the pairing is established, and the individual client terminal and the common client terminal mutually hold their paired counterparts information.

Individual Client Terminal Acquires Information from Common Client Terminal to Perform Pairing Process Via Management System (Display Token Character String on One of Common Client Terminal or Individual Client Terminal and Manually Input Token Character String Into the Other One

FIGS. 10 and 15 have illustrated the process examples in which a 2D code is displayed on the screen of one of the terminals and the 2D code reader of the other terminal reads the displayed 2D code. However, when the 2D code reader is not available, a token character string may be displayed on a screen of one of the terminals, and a user may be able to manually input the displayed token character string into the other terminal by visually observing the displayed token character string. Content included in the token character string may be similar to that included in the 2D code, and other processes are similar to those illustrated in FIGS. 10 and 15 except a technique for transmitting information.

Pairing Performed By Direct Communications Between Individual Client Terminal and Common Client Terminal

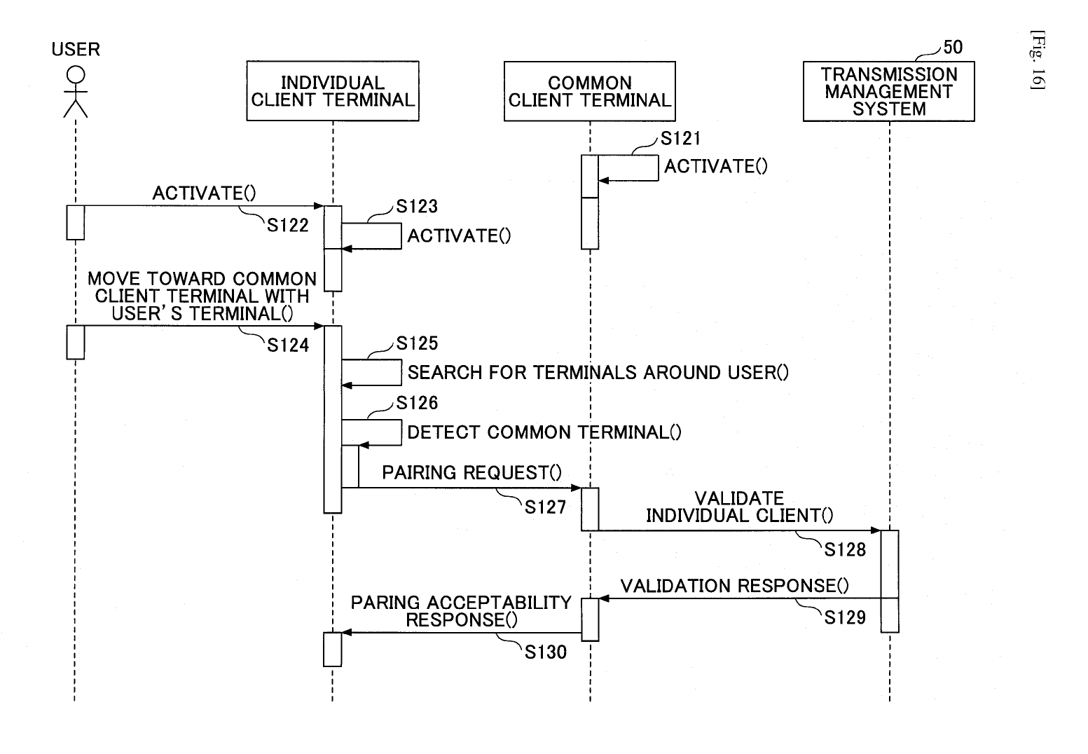

FIG. 16 is a sequence diagram illustrating another process example of pairing. This example employs a transmission unit capable of performing bidirectional communications such as an NFC, Bluetooth, Wifi, and the like. This example allows direct communications between the individual client terminal and the common client terminal, and does not require relay by the transmission management system 50. However, the transmission management system 50 is employed for verifying whether a client terminal serving as pairing partner is valid although this process is not mandatory.

As illustrated in FIG. 16, when the common client terminal is activated (step S121), the common client terminal logs in with a common account in the activating process to display a destination list relating to the common client terminal.

When the user activates an individual client terminal (step S122), the individual client terminal logs in with an individual account in the activating process to display a destination list relating to the individual client terminal (step S123).

When the user carrying the individual client terminal subsequently moves toward the common client terminal (step S124), the individual client terminal searches for terminals around the individual client terminal by the basic bidirectional communications function (step S125), and detects a common client terminal (step S126). The individual client terminal transmits a pairing request to the detected common client terminal by direct communications (step S126).

The common client terminal that has received the pairing request transmits a verification request for verifying the individual client terminal of the request source to the transmission management system 50 (step S128), and receives a verification result response from the transmission management system 50 (step S129). The common client terminal transmits a pairing acceptability response to the individual client terminal based on the verification result response by direct communications (step S130).

Individual Client Terminal Acquires Neighboring Common Client Terminal Information Via Transmission Management System

The individual client terminal having a positional information acquisition unit such as a global positioning system (GPS) or the like may be able to transmit its positional information to the transmission management system 50 to search for a neighboring common client terminal, positional information of which is registered in advance. The transmission management system 50 may be able to subsequently provide an address of a corresponding one of the common client terminals to the individual client terminal, which allows the individual client terminal to transmit a pairing request to the corresponding common client terminal via the transmission management system 50. This technique may also be applied to a case where when the individual client terminal reports that the user of the identification information enters a specific room to the transmission management system 50, the individual client terminal automatically transmits a pairing request to the common client terminal residing in the specific room.

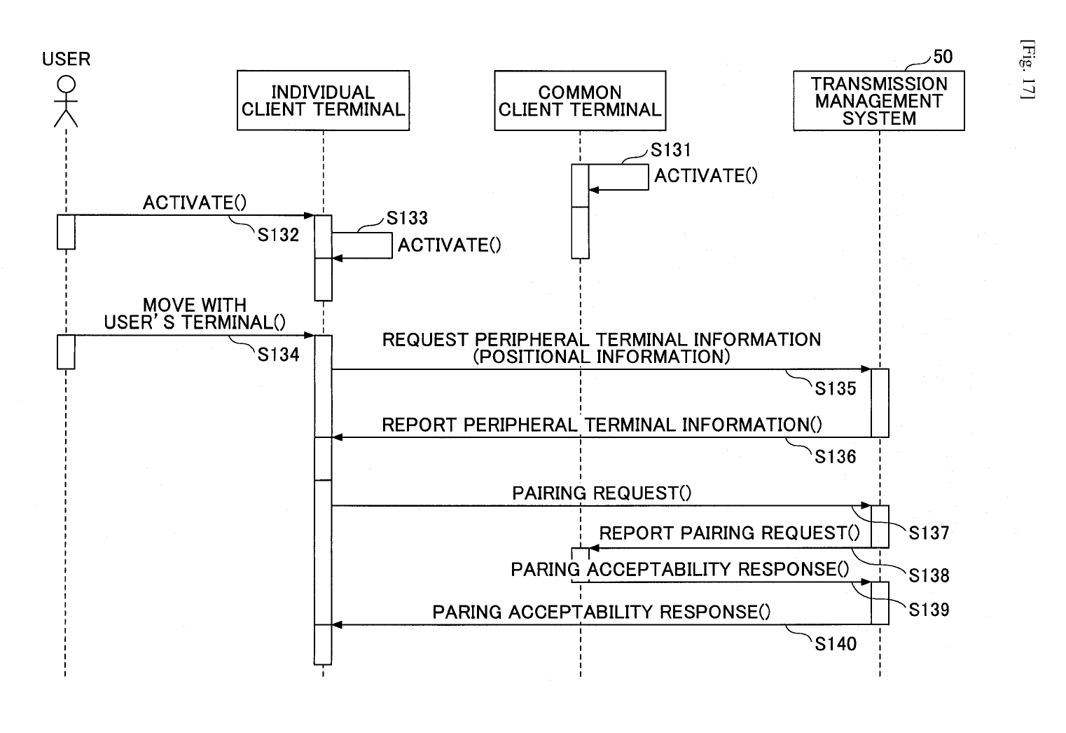

As illustrated FIG. 17, when the common client terminal that includes a positional information acquisition unit such as GPS is activated (step S131), the positional information acquisition unit estimates a position of the own common client terminal, and registers the positional information of the common client terminal into the transmission management system 50. When the common client terminal does not include a positional information acquisition unit, an administrative user registers the positional information of the common client terminal into the transmission management system 50 via a management utility.

When the individual client terminal is activated (step S132), the activation process is performed (step S133), and a position of the own individual client terminal is estimated by using GPS or the like.

When the user carrying the individual client terminal moves (step S134), the individual client terminal transmits a request for neighboring common client terminal information together with the positional information of the own individual client terminal to the transmission management system 50 (step S135).

In response, the transmission management system 50 searches for a corresponding common client terminal located close to the individual client terminal based on the registered positional information of the common client terminals. When the transmission management system 50 finds (detects) the corresponding common client terminal, the transmission management system 50 transmits a report together with information specifying the detected common client terminal to the individual client terminal (step S136).

The individual client terminal that has received the report transmits a pairing request to the detected common client terminal via the transmission management system 50 (steps S137 and S138).

The common client terminal that has received a report of the pairing request transmits a pairing acceptability response to the individual client terminal via the transmission management system 50 (steps S139 and S140). When the pairing is acceptable, the pairing is established, and the individual client terminal and the common client terminal mutually hold their paired counterparts information.

Incoming Call

Via Individual Conference

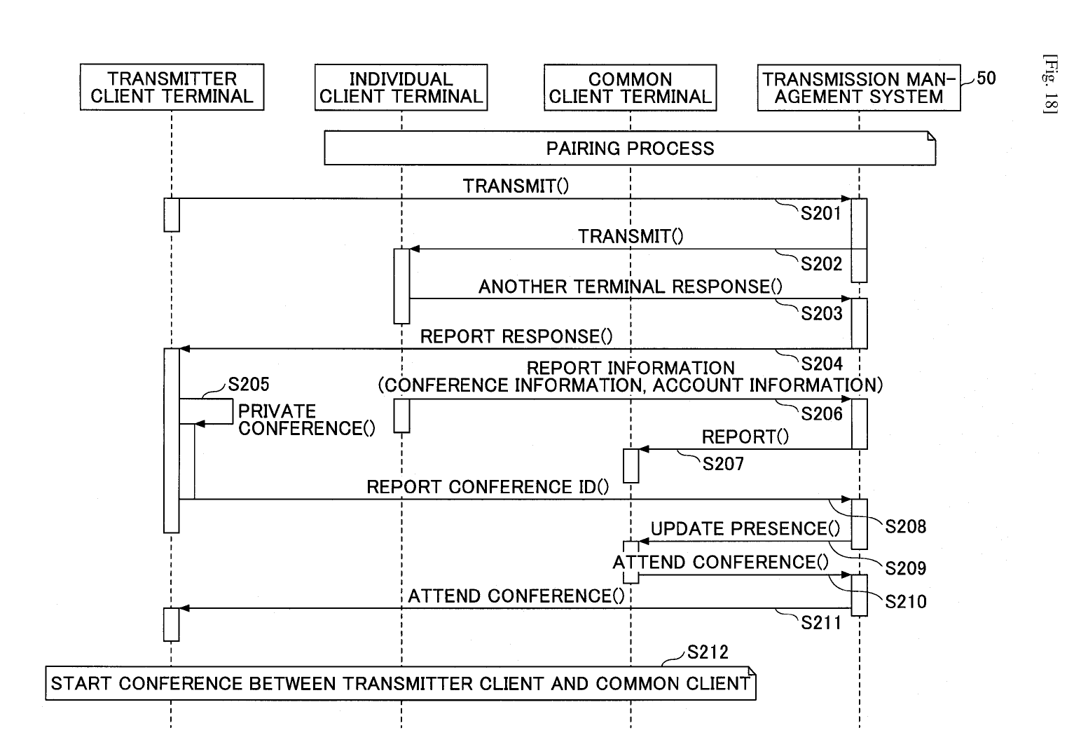

FIG. 18 is a sequence diagram illustrating a process example upon receipt of an incoming call. The process example of FIG. 18 assumes that the pairing process has already been performed in advance. Thus, when a sender client terminal (regardless of the special-purpose apparatus and the general-purpose apparatus) transmits an outgoing call to an individual account (step S201), an individual client terminal receives an incoming call from the sender client terminal via the transmission management system 50 (step S202). This is because a terminal that is in a login status with the individual account while being paired is the individual client terminal.

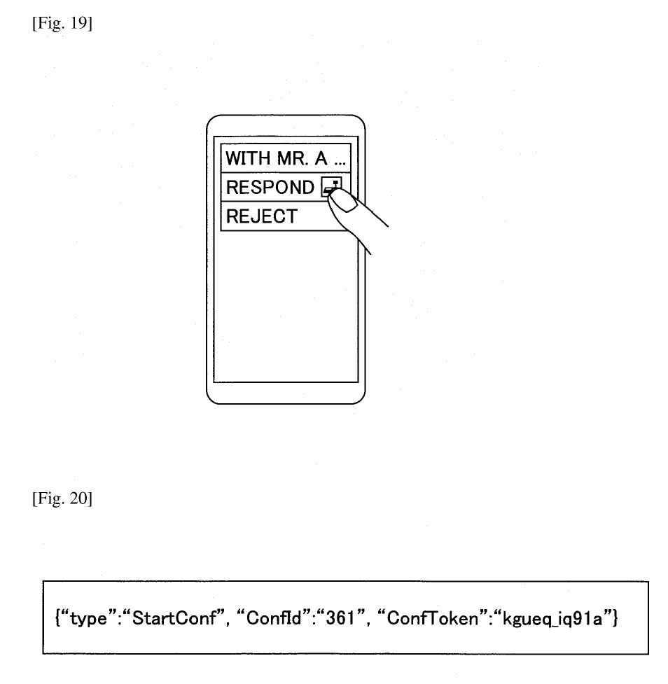

When a user uses the individual client terminal to transmits a response to start a conference by the common client terminal, the individual client terminal transmits another terminal response to the transmission management system 50 (step S203). FIG. 19 is a diagram illustrating an operation example of responding to an individual client terminal upon receipt of an incoming call. FIG. 19 specifically illustrates an example in which the user (a receiver) selects “a response to start a conference by common client terminal” from optional responses of “a response to start a conference normally”, “a response to start a conference by common client terminal”, and “a response to reject” with respect to a sender “Mr. A”. Note that receiving an incoming call while being paired may automatically transmit a “response to start TV conference by common client terminal”.

Referring back to FIG. 18, the transmission management system 50 transmits a report of another terminal response to the sender client terminal (step S204), the sender client terminal starts an individual (private) conference (step S205).

The individual client terminal reports conference information specifying both a sender and a receiver of the TV conference and authorization information (e.g., login information) for using the TV conference service with individual accounts to the transmission management system 50 based on information about a counterpart of the predetermined pair (step S206). The transmission management system 50 subsequently transmits the received information to the common client terminal (step S207). Note that pairing is performed by a unit configured to allow direct communications between the individual client terminal and the common client terminal such as an NFC, Bluetooth, Wi-Fi, or the like, the information may be transmit directly without intervention of the transmission management system 50.

On the other hand, the sender client terminal that has started the individual conference reports a conference ID specifying the TV conference to the transmission management system 50 (step S208). The transmission management system 50 subsequently updates the presence of the common client terminal based on the received conference ID (step S209).

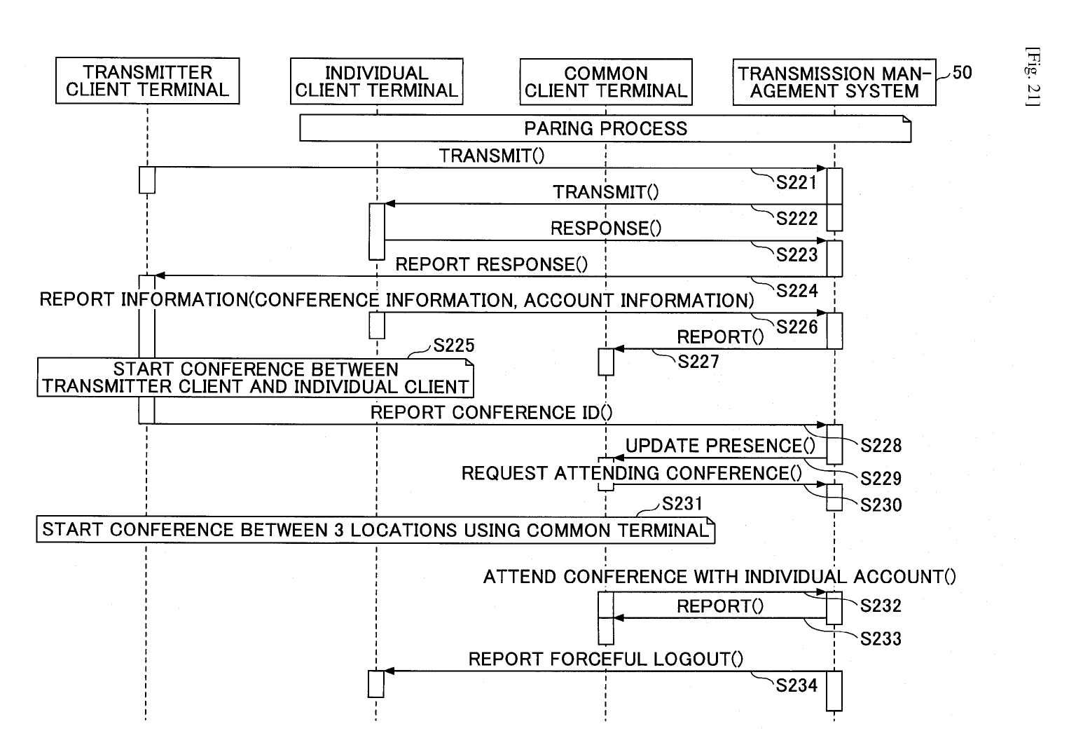

The common client terminal then transmits a conference attendance request to the transmission management system 50 by specifying the conference ID (step S210). In this step, the common client terminal may re-log in with an individual account or may re-establish connection instead of the re-login, based on the authorization information. FIG. 20 is a diagram illustrating an example of conference attendance data, which include a type : “StartCOnf”, a conference ID “ConfID”: “361”, and authorization information “ConfToken”: “kgueq_ip91a”.

Referring back to FIG. 18, the transmission management system 50 reports the conference attendance to the sender client terminal (step S211), and starts the TV conference between the sender client terminal and the common client terminal (step S212).

As behaviors after the TV conference has started, the status of the individual client terminal may be any status insofar as there is no limitation from the transmission management system 50. However, when the user performs a TV conference using a different client terminal including the individual client terminal during the TV conference being held by the common client terminal using the individual account, the individual client terminal may be configured to be in a logout status by performing exclusive control. The status of the TV conference may display a combination of the common client terminal name and the individual account name, which is used by display of attendees. Further, transmission of incoming call to any of the individual account and the common account may allow the user to attend the TV conference in the middle of the conference. The common client terminal does not maintain a login status with the individual account. Hence, when the TV conference using the individual account is finished, the common client terminal returns to the status the same as the standby status immediately after the activation of the common client terminal.

Via Three-Locational Conference

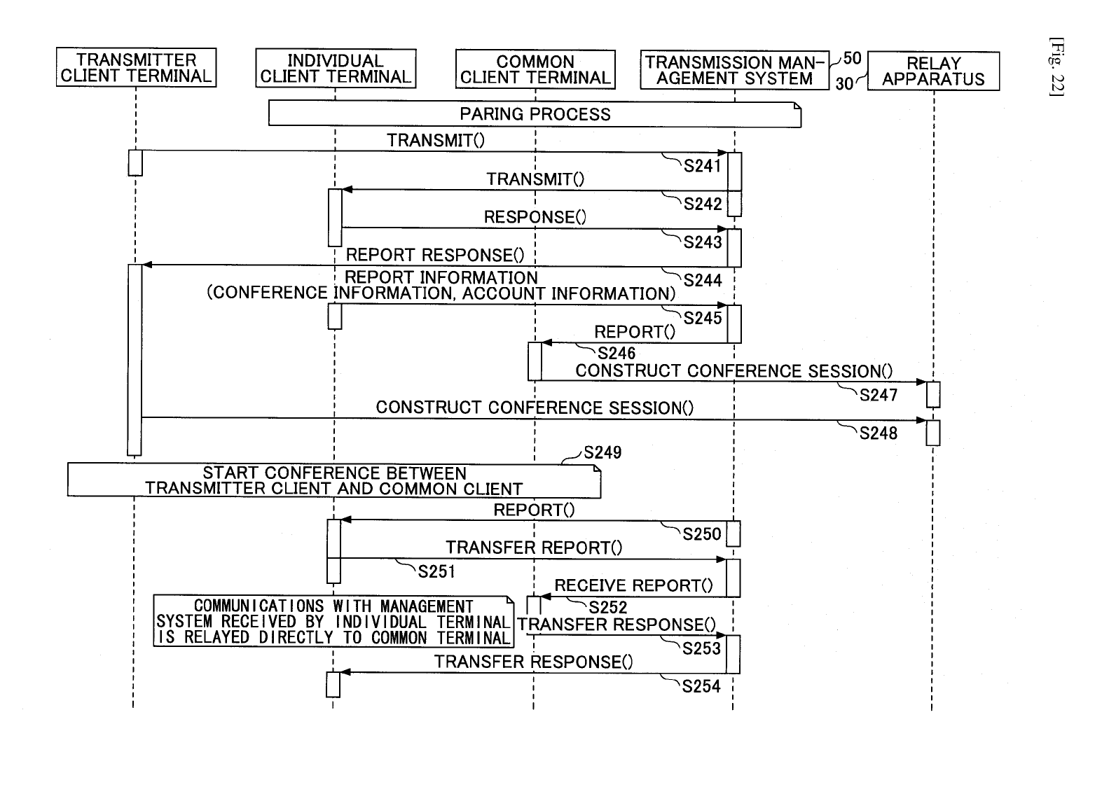

FIG. 21 is a sequence diagram illustrating another process example upon receipt of an incoming call. The process example of FIG. 21 assumes that the pairing process has already been performed in advance. Thus, when a sender client terminal (regardless of the special-purpose apparatus and the general-purpose apparatus) transmits an outgoing call to an individual account (step S221), an individual client terminal receives an incoming call from the sender client terminal via the transmission management system 50 (step S222). This is because a terminal that is in a login status with the individual account while being paired is the individual client terminal.

When a user uses the individual client terminal to transmit a response to start a conference by the common client terminal, the individual client terminal transmits a normal response to the transmission management system 50 (step S223).

The transmission management system 50 transmits a response to the sender client terminal (step S224), and starts a conference between the sender client terminal and the individual client terminal (step S225). Note that in this step, the individual client terminal does not actually move to the conference, and does not shift to a conference screen.

The individual client terminal reports conference information specifying both a sender and a receiver of the TV conference and authorization information (e.g., login information) for using the TV conference service with individual accounts to the transmission management system 50 based on information about a counterpart of the predetermined pair (step S226). The transmission management system 50 subsequently transmits the received information to the common client terminal (step S227). Note that pairing is performed by a unit configured to allow direct communications between the individual client terminal and the common client terminal such as an NFC, Bluetooth, Wi-Fi, or the like, the information may be transmit directly without intervention of the transmission management system 50.

On the other hand, the sender client terminal reports a conference ID specifying the TV conference to the transmission management system 50 (step S228). The transmission management system 50 subsequently updates the presence of the common client terminal based on the received conference ID (step S229).

The common client terminal then transmits a conference attendance request to the transmission management system 50 by specifying the conference ID (step S230). Thus, a three-locational conference between the sender client terminal, the individual client terminal, and the common client terminal starts (step S231).

The common client terminal subsequently transmits a conference attendance request to attend a conference with the individual account based on authorization information to the transmission management system 50 (steps S232 and S233). The transmission management system 50 subsequently transmits a forced logout report to the individual client terminal (step S234), and the three-locational conference shifts to a three-locational conference between the sender client terminal and the individual client terminal.

Construction of Conference Session

FIG. 22 is a sequence diagram illustrating another process example upon receipt of an incoming call. The process example of FIG. 22 assumes that the pairing process has already been performed in advance. Thus, when a sender client terminal (regardless of the special-purpose apparatus and the general-purpose apparatus) transmits an outgoing call to an individual account (step S241), an individual client terminal receives an incoming call from the sender client terminal via the transmission management system 50 (step S242). This is because a terminal that is in a login status with the individual account while being paired is the individual client terminal.

When a user uses the individual client terminal to transmits a response to start a conference by the common client terminal, the individual client terminal transmits a normal response to the transmission management system 50 (step S243). The transmission management system 50 reports a response to the sender client terminal (step S244).

The individual client terminal reports conference information specifying both a sender and a receiver of the TV conference and authorization information (e.g., login information) for using the TV conference service with individual accounts to the transmission management system 50 based on information about a counterpart of the predetermined pair (step S245). The transmission management system 50 subsequently transmits the received information to the common client terminal (step S246). Note that pairing is performed by a unit configured to allow direct communications between the individual client terminal and the common client terminal such as an NFC, Bluetooth, Wi-Fi, or the like, the information may be transmit directly without intervention of the transmission management system 50.

The common client terminal and the sender client terminal transmit respective conference session construction requests to the relay apparatus 30 (steps S247 and S248). Note that a license management session and a TV conference session are mutually independent of each other. Thus, a TV conference starts between the sender client terminal and the common client terminal (step S249).

Thereafter, when the transmission management system 50 transmits a report relating to authentication-authorization to the individual client terminal (step S250), the individual client terminal transmits the received report to the common client terminal via the transmission management system 50 (steps S251 and S252). The common client terminal subsequently transmits a response to the individual client terminal via the transmission management system 50 (steps S253 and S254).

Outline

The disclosed embodiments illustrate the collaboration of the special-purpose apparatus and the general-purpose apparatus, which enables users to use individual accounts to operate the special-purpose apparatus with excellent security.

Note that the special-purpose apparatus may include at least one software component or hardware component exhibiting the performance differing from the performance of the corresponding software component or hardware component of the general-purpose apparatus. Note also that not all the performances of the hardware components of the special-purpose apparatus are higher than those of the hardware components of the general-purpose apparatus.

In the above-described embodiments, a TV conference-specific terminal is illustrated as an example of the special-purpose apparatus. However, the special-purpose apparatus is not limited to this example. The special-purpose apparatus may be other special-purpose apparatus such as an IP (Internet protocol) phone or an Internet phone. The special-purpose apparatus may also be a smartphone, a tablet terminal, a mobile phone, a car navigation terminal, a wearable computer, a camera, a projector, an electronic whiteboard, a game machine, and an electronic signage (digital signage), or an industrial apparatus having communications functions. The wearable computer includes a watch, a head-mounted display, and the like. The industrial apparatus includes an office apparatus such as multifunctional peripheral/printer/produce and the like, a medical instrument such as an endoscope, and an agricultural apparatus such as a cultivator.

The general-purpose apparatus may include a notebook PC, a smartphone, a tablet terminal, a mobile phone, and a wearable computer.

The above-described transmission management system 50, relay apparatus 30, and program providing system 90 may be constructed by a single computer, or may be constructed by multiple computers to each of which a corresponding one of components (functions and units) of the transmission management system 50, relay apparatus 30, and program providing system 90 are discretely assigned. In addition, when the program providing system 90 is constructed by a single computer, the programs transmitted by the program providing system 90 may be divided into multiple modules or the programs may be transmitted without being divided into multiple modules. Further, when the program providing system 90 is constructed by multiple computers, the programs may be divided into multiple modules assigned to the computers, each of which may be transmitted from a corresponding one of the computers.

The preferred embodiments are described above. The above-described embodiments illustrate specific examples of the invention; however, the present invention is not limited to these examples, and various alterations or changes may be made without departing from the gist and the scope of the claims of the present invention. Specifically, the present invention shall not be construed as being limited to details of the specific examples and accompanying drawings thereof.

Correspondence Between Terms in the Embodiments and Terms in the Claims

The “common client terminal” is an example of a “first transmission terminal” in the claims. The “individual client terminal” is an example of a “second transmission terminal” in the claims. The “special-general apparatus collaborating part 1-22” is an example of the “pairing unit”, the “transmitting unit”, the “receiving unit”, or the “communications start unit” in the claims.

### REFERENCE SIGNS LIST

1 transmission system

2 communications network

10, 20 transmission terminal

11 communications part

12 operations input receiver

13 login request part

14 imaging part

15a sound-voice input part

15b sound-voice output part

16 display controller

18 delay detector

19 storing-reading processor

1-20 destination list creator

1-21 user authentication receiver

1-22 special-general apparatus collaborating part

1000 nonvolatile storage

1002 volatile storage

30 relay apparatus

31 communications part

32 status detector

33 data quality verification part

34 change quality manager

35 data quality change part 35

39 storing-reading processor

3000 nonvolatile storage

3001 change quality management DB

50 transmission management system

51 communications part

52 authentication part

53 status manager

54 terminal extracting part

55 terminal status acquisition part

57 session manager

58 quality determination part

59 storing-reading processor

60 delay time manager

62 destination determination part

5000 nonvolatile storage

5001 relay apparatus management DB

5002 authentication management DB

5003 terminal management DB

5004 destination list management DB

5005 session management DB

5007 quality management DB

5100 volatile storage

The present application is based on and claims the benefit of priority of Japanese Priority Application No. 2015-054028 filed on Mar. 17, 2015, the entire contents of which are hereby incorporated herein by reference.

1. A transmission system comprising:
a first transmission terminal; and
a second transmission terminal, wherein
the second transmission terminal includes
a pairing unit configured to perform pairing between the first transmission terminal and the second transmission terminal; and
a transmitting unit configured to transmit, upon receipt of a communications start request from a third transmission terminal, information specifying communications with the third transmission terminal and individual account information of the second transmission terminal to the first transmission terminal on which the pairing is performed, wherein
the first transmission terminal includes
a pairing unit configured to perform pairing between the first transmission terminal and the second transmission terminal;
a receiving unit configured to receive information specifying communications with the third transmission terminal and individual account information of the second transmission terminal from the second transmission terminal on which the pairing is performed; and
a communications start unit configured to start communications with the third transmission terminal based on the received information.

2. The transmission system as claimed in claim 1, wherein
the individual account information serves as authorization information for using a transmission service with an individual account.

3. The transmission system as claimed in claim 1, wherein
the pairing unit performs the pairing by displaying an identification code of an own terminal on a screen of one of the first transmission terminal and the second transmission terminal, specifying a counterpart terminal by displaying the identification code of the own terminal from the other one of the first transmission terminal and the second transmission terminal, and performing communications with the specified counterpart terminal.

4. The transmission system as claimed in claim 1, wherein
the pairing unit performs the pairing by displaying a token character string for identifying an own terminal on a screen of one of the first transmission terminal and the second transmission terminal, specifying a counterpart terminal from a token character string manually input into the other one of the first transmission terminal and the second transmission terminal, and performing communications with the specified counterpart terminal.

5. The transmission system as claimed in claim 1, wherein
the pairing unit performs pairing by performing communications directly between the first transmission terminal and the second transmission terminal such that the first transmission terminal and the second transmission terminal perform communications with each other.

6. The transmission system as claimed in claim 1, wherein
the pairing unit of the second transmission terminal performs the pairing by causing a position information management device managing positional information of the first transmission terminal to search for terminals around an own terminal based on positional information of the own terminal, specifying a counterpart terminal, and performing communications with the specified counterpart terminal.

7. The transmission system as claimed in claim 1, wherein
the authorization information includes login information of a user who uses the second transmission terminal.

8. The transmission system as claimed in claim 1, wherein
the communications start unit of the first transmission terminal attends an individual conference with the individual account, the individual conference being started by a sender transmission terminal.

9. The transmission system as claimed in claim 1, wherein
the communications start unit of the first transmission terminal attends a conference with the individual account, the conference being started between a sender transmission terminal and the second transmission terminal.

10. The transmission system as claimed in claim 1, wherein
the communications start unit of the first transmission terminal attends a conference by a conference session constructed by a sender transmission terminal and the individual account.

11-12. (canceled)

13. A method performed by a first transmission terminal and a second transmission terminal, each of the first transmission terminal and the second transmission terminal being configured to perform pairing between each other, the method comprising:
causing the second transmission terminal to perform pairing with the first transmission terminal;
causing the second transmission terminal to transmit, upon receipt of a communications start request from a third transmission terminal, information specifying communications with the third transmission terminal and individual account information of the second transmission terminal to the first transmission terminal on which the pairing is performed;
causing the first transmission terminal to receive information specifying communications with the third transmission terminal and individual account information of the second transmission terminal from the second transmission terminal on which the pairing is performed; and
causing the first transmission terminal to start communications with the third transmission terminal based on the received information.

14. (canceled)
